(19) United States
(12) Patent Application Publication
(10) Pub. No.: US 2009/0114619 A1
(43) Pub. Date: May 7, 2009

(54) WET ETCHING METHOD AND WET ETCHING APPARATUS

(75) Inventors: Ryuji Sotoaka, Tokyo (JP); Keiichi Tanaka, Tokyo (JP); Tomoyuki Azuma, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Mitsubishi Gas Chemical Company Inc.

(21) Appl. No.: 12/094,103

(22) PCT Filed: Nov. 17, 2006
(86) PCT No.: PCT/JP2006/322920

§ 371 Date: May 16, 2008

(30) Foreign Application Priority Data
Nov. 18, 2005 (JP) 2005 335048
Nov. 28, 2005 (JP) 2005 341849

(51) Int. Cl. B44C 1/22; C23F 1/08

(52) U.S. Cl. 216/48; 216/94; 156/345.11; 156/345.23

(57) ABSTRACT

A fine pattern is formed on a surface of a processing object without using photoresist. A wet etching for the processing object in an area to which ultraviolet light is applied is performed by bringing a solution in which nitrous oxide (N₂O) is dissolved into contact with the processing object and applying the ultraviolet light to the solution in a vicinity of an area to the processing object other than portions shielded with a mask whereupon a light shielding pattern is formed.

### TECHNICAL FIELD

The present invention relates to a method of partially etching away a surface of a processing object, and to an apparatus thereof.

### BACKGROUND ART

An etching method which partially etches a surface of a processing object is used in a manufacturing process of a transistor formed by processing a surface of a semiconductor substrate, and in a manufacturing process of an LSI in which the transistor is highly integrated. Also, in an electronic part with a small degree of integration, it is used in a process of processing a printed substrate or flexible printed substrate, or a lead frame used in mounting a semiconductor chip, or the like. In these processes, various kinds of wiring pattern for transmitting an electrical signal, and the like, are formed by forming conductor layers on a surface of a silicon substrate or insulating substrate, and partially etching away the conductor layers. This process is generally called a photolithography and etching process.

A description will be given, using FIG. 18, of a method of forming a wiring pattern of a printed substrate used in, for example, an electronic circuit. FIG. 18(a) shows a cross section of a printed substrate 302, in which copper foil 301 is formed laminated on an insulating substrate 300. A photoresist 303, made of a highly photosensitive resin, is painted on the copper foil 301 of the printed substrate 302, as shown in FIG. 18(b). Then, as shown in FIG. 18(c), a mask 304, on which is formed a light intercepting pattern 305, is disposed between the printed substrate 302 and a light source, and the photoresist 303 is exposed by applying an exposing light 306. The light being blocked in an area of the light intercepting pattern 305, and not transmitted, a photoresist 303a immediately below is not exposed, while the light is transmitted in an area in which the pattern 305 is not formed, and a photoresist 303b is exposed. FIG. 18(d) is a sectional view showing a condition in which the photoresist 303 is developed. As a negative type is used as the photoresist 303, an exposed portion is removed, while a portion of the photoresist 303a which is not exposed remains on the copper foil 301. In this way, the pattern 305 of the mask 304 is transferred as the photoresist 303a.

Next, a copper foil 301 etching process is carried out. The printed substrate 302, on which is formed the pattern of the photoresist 303a, is immersed in a copper etching solution. By so doing, as shown in FIG. 18(e), a portion of the copper foil 301 on which the photoresist 303a is not formed is removed from the printed substrate. Next, the photoresist 303a is removed. As shown in FIG. 18(f), the pattern 305 of the mask is transferred to, and remains on, the insulating substrate 300 as a pattern of the copper foil 301.

An etching of the copper foil 301 is normally carried out by means of a chemical reaction with a solution. As a kind of etching solution, an aqueous solution of copper chloride, ferric chloride, persulfates, hydrogen peroxide/sulfuric acid, copper ammonium complex ion, or the like, is common. In the event of using, for example, hydrogen peroxide/sulfuric acid as the etching solution, a chemical reaction occurring in the solution can be considered to have the following kind of mechanism.

Firstly, Cu is oxidized by H₂O₂.

Cu+H₂O₂→CuO+H₂O

Next, the CuO dissolves as copper sulfate.

CuO+H₂SO₄→CuSO₄+H₂O

In this case, Cu is inferior compared with CuO as regards an ease of generating soluble copper sulfate. For this reason, it is possible to suppose that a hydrogen peroxide solution, which is an oxidizing agent, is added to the etching solution. In other words, the Cu is not dissolved in the sulfuric acid until it is oxidized.

Meanwhile, recently, there is also known a method of carrying out an etching of a desired area by applying light in a controlled way to an object substance disposed in a solution. For example, in Patent Document 1, a method is disclosed whereby, by carrying out heat treatment by applying light in a controlled way to silicon disposed in an etching solution, an area of the silicon to be etched is selected freely. With this etching, a formation of the previously described kind of photoresist pattern, or the like, for protecting an etched area is not particularly necessary.

Also, another etching method using light is disclosed in Patent Document 2. That is, carrying out an application of light to a specified portion of a substance in a solution, by means of a pulse laser or the like, locally heating it to around a melting point of the substance, the relevant portion of the substance is oxidized, generating an oxide. Then, the method is such that, carrying out a localized heating again after once cooling, the oxide is dispersed in the solution.

### Patent Document 1: JP-A-2004-172482

### Patent Document 2: JP-A-06-260477

However, with an etching according to a heretofore known method of forming a wiring or the like on a printed substrate, a pattern formation process with a photoresist is essential. Specifically, a photoresist painting process, a drying process, a photoresist development process, a photoresist stripping process, and the like, are necessary. For this reason, facilities for carrying out each process are necessary.

Specifically, apparatus such as a photoresist processing apparatus, an exposure apparatus, an etching apparatus, a photoresist removal apparatus, and a cleaning apparatus are necessary.

The photoresist processing apparatus is an apparatus for carrying out a painting of a photoresist on a substrate, and a heat treatment of the substrate on which the photoresist is painted.

The exposure apparatus is an apparatus for, placing a mask on which a desired pattern is depicted over the substrate after the photoresist process, carrying out an exposure by applying ultraviolet light from above.

The etching apparatus is an apparatus for performing an etching process on the substrate after the exposure.

The photoresist removal apparatus is an apparatus for dissolving photoresist remaining on a surface of the substrate after the etching by means of an organic solvent.

### DISCLOSURE OF THE INVENTION

### Problems that the Invention is to Solve

With the etching according to the heretofore known method of forming a wiring or the like on a printed substrate, as heretofore described, a pattern formation process with a photoresist is essential. For this reason, as a number of manufacturing processes increases, and facilities for carrying out each process are necessary, there has been a problem in that there is a possibility of a deterioration in productivity, or an increase in cost.

Also, in the event that a hydrogen peroxide solution or the like is dumped as a waste liquid without being treated, there has been a danger of causing environmental damage. For this reason, with an etching method which uses these, a waste liquid disposal is necessary. Furthermore, there has been a problem in that, when implementing a recovery and reuse of copper or the like dissolved in a waste liquid, a recovery rate deteriorates due to a side reaction of a breakdown of a hydrogen peroxide solution which prevents a deposit of copper or the like at an electrode.

Meanwhile, with a technology disclosed in Patent Document 1, although it does not use a photoresist material, substances on which an etching can be performed are limited. That is, applying polarized light rays to a substance which is a processing object, and exciting electrons from a surface of the substance, an area to which light is applied is etched by means of a solution in which hydrogen fluoride and hydrogen peroxide are mixed at a ratio of one to one. The etching accompanying the phenomenon of exciting the electrons from the substance, an amount of etching is dependent on a polarization direction of the light and a crystal orientation of the substance. For this reason, as a processing material must be one from which electrons are easily excited by a light application, and the etching is dependent on the polarization direction of the light and a crystal orientation of the processing material, there is a problem in that an application range thereof is extremely limited. In addition, as a hydrogen peroxide solution is used as the etching solution, there are the heretofore described problems of the waste liquid disposal, etching material recovery, and the like.

Also, with a technology disclosed in Patent Document 2, although it does not use a photoresist pattern, it heats a processing object to around a melting point by means of a laser beam, cools it, reheats it, and disperses the processing object utilizing a thermal expansion coefficient difference. For this reason, it is difficult to apply it to a kind of process which forms a fine pattern, such as a semiconductor process, which has an extreme aversion to a generation of fine particles such as dust.

Meanwhile, with the heretofore described apparatus for carrying out a photolithograpy and etching process, as heretofore described, as there is a broad array of processes, a large number of apparatus are necessary. Also, as a hydrogen peroxide solution, with which there is a danger of having a detrimental effect on a human body or the environment, is used as an etching solution, facilities for safety measures and environmental measures are also necessary. For this reason, there has been a flaw in that a structure becomes complex and large scale.

### Means for Solving the Problems

In order to solve the heretofore described problems, following means are implemented.

In the invention, a wet etching method is configured to comprise the steps of: bringing a solution in which nitrous oxide (N₂O) is dissolved into contact with a processing object, and by applying ultraviolet light to the solution in an area in which it is in contact, dissolving away the processing object in a vicinity of an area to which the ultraviolet light is applied.

In the invention, a wet etching method is configured to comprise the steps of: by applying ultraviolet light to a solution in which nitrous oxide (N₂O) is dissolved to dissociate oxygen, allowing the dissociated oxygen to oxidize a processing object to generate an oxide, and allowing the generated oxide to dissolve in the solution and be removed.

In the invention, the previously described wet etching methods are such that the solution includes nitrous oxide of a concentration in a range from 10 ppm to 5,000 ppm.

In the invention, any previously described wet etching method is such that the solution includes at least any one of water, methanol, ethanol, isopropanol, methylcyclohexane, cyclohexane, acetonitryl, hexane, dioxane, glycerine, n-pentane, or dichloromethane.

In the invention, any previously described wet etching method is such that the solution is a solution to which an acid or an alkali is added.

In the invention, the previously described wet etching method is such that the solution is a solution which includes any acid of sulfuric acid, phosphoric acid, hydrochloric acid, boric acid, carbonic acid, hydrofluoric acid, nitric acid, formic acid or acetic acid.

In the invention, the previously described wet etching method is such that the solution is a solution which includes any alkali of ammonia, sodium hydroxide, potassium hydroxide, or tetramethylammonium hydroxide.

In the invention, any previously described wet etching method is such that the ultraviolet light is ultraviolet light having a spectrum with a wavelength range of 173 nm to 240 nm.

In the invention, any previously described wet etching method is such that the ultraviolet light is ultraviolet light emitted by a mercury lamp.

In the invention, any previously described wet etching method is such that the ultraviolet light is ultraviolet light emitted by an excimer lamp.

In the invention, any previously described wet etching method is such that the processing object is one kind chosen from silicon, aluminium, copper, iron, zinc, titanium, tantalum, silver, zirconium, tungsten, chromium, molybdenum, nickel, hafnium, ruthenium, niobium, yttrium, scandium, neodymium, lanthanum, cerium, cobalt, vanadium, manganese, gallium, germanium, indium, tin, rhodium, palladium, cadmium, antimony, or an alloy including these.

In the invention, any previously described wet etching method is such that the processing object is a processing substrate wherein a copper film is formed on the substrate.

In the invention, any previously described wet etching method is such that the processing object is a silicon substrate.

In the invention, any previously described wet etching method is such that the processing object is a processing substrate wherein a molybdenum film is formed on the substrate.

In the invention, any previously described wet etching method is such that the ultraviolet light is locally applied to the solution in a vicinity of the processing object.

In the invention, any previously described wet etching method is such that the ultraviolet light is applied to the solution in the vicinity of the processing object except for in portions blocked by a mask.

In the invention, any previously described wet etching method is such that a volume of the processing object dissolved away is controlled by controlling an application time of the ultraviolet light.

In the invention, any previously described wet etching method is such that a depth to which the processing object is dissolved away is controlled by controlling the application time of the ultraviolet light.

In the invention, any previously described wet etching method is such that the processing object is brought into contact with the solution by immersing it therein.

In the invention, any previously described wet etching method is such that the solution is supplied to, and brought into contact with, a surface of the processing object.

In the invention, a wet etching apparatus including contact means which brings a solution in which nitrous oxide is dissolved into contact with a processing object, and light application means which applies ultraviolet light to the solution in an area in which it is in contact, is configured in such a way as to etch the processing object in a vicinity of an area to which the ultraviolet light is applied by the light application means.

In the invention, the previously described wet etching apparatus is such that the contact means has solution holding means for holding the solution in which the nitrous oxide is dissolved, and processing object holding means for holding the processing object, and the light application means has a light source which emits ultraviolet light, and mask supporting means for interposing a light intercepting mask between the light source and the processing object holding means.

In the invention, the previously described wet etching apparatus is such that the contact means has the solution holding means for holding the solution in which the nitrous oxide is dissolved, and the processing object holding means for holding the processing object, and further has solution supply means for supplying the solution from the solution holding means to the processing object, and the light application means has the mask supporting means for interposing the light intercepting mask between the light source and the processing object holding means.

In the invention, any previously described wet etching apparatus is such that the light application means has the light source which emits the ultraviolet light, and optical path adjustment means for applying the emitted ultraviolet light to the processing object.

In the invention, any previously described wet etching apparatus is such that the optical path adjustment means is a lens made of quartz for collecting the ultraviolet light.

### ADVANTAGES OF THE INVENTION

According to the invention, as a solution in which nitrous oxide (N₂O) is dissolved and a processing object are brought into contact, it is possible to etch the processing object by applying ultraviolet light to the solution in an extreme vicinity of the processing object it is wished to etch away, without using a photo process which uses a photoresist. For this reason, it is possible to reduce a process quantity, and carry out the etching simply. Furthermore, as it is possible to carry out the etching of the processing object without using a hydrogen peroxide solution, it is possible to safely implement a transportation or the like of a waste liquid, with no side reaction of a breakdown of the hydrogen peroxide solution. Also, it becoming easier to recover material of the processing object from the waste liquid, it is possible to provide a wet etching which is effective in an environmental program.

According to the invention, as the wet etching method is such that ultraviolet light is applied to a solution in which nitrous oxide (N₂O) is dissolved, dissociating oxygen, the dissociated oxygen oxidizes a processing object, forming an oxide, and the generated oxide dissolves in the solution and is removed, as well as it being possible to carry out the etching of the processing object without depending on a direct interaction between the processing object and the ultraviolet light applied, there being no need either to expose the processing object to a high temperature, it is possible to increase a range of options for a processing object which is a subject of the etching.

According to the invention, as the etching is carried out using a solution including nitrous oxide of a concentration in a range from 10 ppm to 5,000 ppm, it is possible to carry out an oxidization with an optimum nitrous oxide concentration.

According to the invention, any previously described wet etching method is such that the solution includes at least any one of water, methanol, ethanol, isopropanol, methylcyclohexane, cyclohexane, acetonitryl, hexane, dioxane, glycerine, n-pentane, or dichloromethane. As these solutions are capable of transmitting light with a wavelength of 240 nm or less, it is possible to carry out an oxidizing process without the ultraviolet light being absorbed by the solution. In particular, as water has a high transmission capability around a wavelength of 190 nm, of all the heretofore mentioned solutions, it can carry out an oxidization process most suited to the invention.

According to the invention, as a dissolution of an oxidized portion is promoted by adding an acid or an alkali to the solution, it is possible to more effectively carry out an etching of only an area to which ultraviolet light is applied.

According to the invention, as any previously described wet etching method is such that the ultraviolet light is ultraviolet light having a spectrum with a wavelength range of 173 nm to 240 nm, it is possible to carry out an oxidizing reaction using light with a wavelength in a range in which nitrous oxide most easily reacts. Also, ultraviolet light in this wavelength range does not commonly exist in the natural world. For this reason, even in the event of throwing waste liquid for disposal, as it is, into a sewer or the like, it does not happen that it has an effect such as to damage nature.

According to the invention, a characteristic is a use of a mercury lamp and an excimer lamp as a source of ultraviolet light. Consequently, by using these lamps, it is possible to produce ultraviolet light which has an optimum light source wavelength range in the wet etching method according to the invention. Also, as the excimer lamp has a good start up and shut down, it is possible to carry out an etching for a predetermined time only by turning the lamp on and off. Also, in the event of stopping an application of ultraviolet light, the processing object is barely dissolved. Furthermore, as the excimer lamp has an excellent characteristic in that there is little generation of ozone due to a light emission, it is possible to reduce a burden on the environment.

According to the invention, any previously described wet etching method is such that the processing object is one kind chosen from silicon, aluminium, copper, iron, zinc, titanium, tantalum, silver, zirconium, tungsten, chromium, molybdenum, nickel, hafnium, ruthenium, niobium, yttrium, scandium, neodymium, lanthanum, cerium, cobalt, vanadium, manganese, gallium, germanium, indium, tin, rhodium, palladium, cadmium, antimony, or an alloy including these. For this reason, as it can also be used with silicon, which is a best material of a semiconductor, it is possible to utilize the invention in a semiconductor industry. Also, as it can also be used with metals and alloys other than silicon, it is also possible to utilize the invention in, for example, a field of precious metal processing, or the like.

According to the invention, as a characteristic is that the processing object is one wherein copper foil is formed on the substrate, it can be utilized in a formation of a printed wiring on the substrate.

According to the invention, as a characteristic is that a molybdenum film is formed on the substrate, it can be utilized in a formation of a liquid crystal color filter black matrix.

According to the invention, as a characteristic is that the ultraviolet light is locally applied to the solution in a vicinity of the processing object, it is possible to smoothly implement an N₂O dissociation mechanism.

According to the invention, by interposing a mask, on which a pattern is formed, between a source of ultraviolet light and the processing object, it is possible to easily transfer the pattern onto the processing object.

According to the invention, as a volume and depth of the processing object dissolved away is controlled by controlling an application time of the ultraviolet light, it is possible to obtain a desired etching pattern.

According to the invention, a characteristic is that the processing object is brought into contact with the solution by immersing it therein. By this means, as it is possible to put a solution into a receptacle and carry out a process, it is possible to easily carry out a process of oxidizing the processing object, and furthermore, to maintain safety.

According to the invention, a characteristic is that the solution is supplied to, and brought into contact with, a surface of the processing object. By this means, as it is possible to minimize an amount of solution used in the oxidizing process, it is possible to carry out an etching economically.

According to the invention, it is possible to achieve the advantages according to the heretofore described methods by means of an apparatus. By this means, as a photolithography process is unnecessary, an apparatus for carrying out such a process is unnecessary. Also, as there is no need to use a hydrogen peroxide solution, with which there is a danger of having a detrimental effect on a human body or the environment, in an etching solution, facilities for safety measures and environmental measures can be reduced. For this reason, a structure being simple and there being considerable license in a design, it is possible to provide a small scale, low cost apparatus.

### BRIEF DESCRIPTION OF THE DRAWINGS

FIG. 1 A schematic view showing a wet etching method in an embodiment;

FIG. 2 A conceptual view showing a configuration of an FE element according to a first embodiment of the invention, where the FE element is disposed in such a way that a display surface 80 is positioned at a front;

FIG. 3 A conceptual view showing the configuration of the FE element according to the first embodiment of the invention, where the FE element is disposed in such a way that the display surface 80 is positioned at a top;

FIG. 4 A schematic sectional view showing the configuration of the FE element according to the first embodiment of the invention;

FIG. 5 An illustration showing a manufacturing process of the FE element according to the first embodiment of the invention;

FIG. 6 An illustration showing a wet etching method for the FE element according to the first embodiment of the invention;

FIG. 7 A schematic diagram showing a wet etching method in a second embodiment of the invention;

FIG. 8 A schematic diagram showing a wet etching method in a third embodiment of the invention;

FIG. 9 A sectional view showing a wet etching apparatus in the first embodiment of the invention;

FIG. 10 A schematic sectional view showing a wet etching apparatus in the second embodiment of the invention;

FIG. 11 A graph showing a silicon substrate oxidization experiment result relating to the invention;

FIG. 12 A schematic sectional view of an experimental apparatus used in experiments of FIGS. 11, 13, 14 and 15;

FIG. 13 A graph showing a relationship between a light application time and a thickness of a silicon oxide film when immersing a silicon substrate W in water in which helium is dissolved, and applying ultraviolet light, causing a formation of a silicon oxide film;

FIG. 14 A graph showing a relationship between an ultraviolet light application time and a light absorption of a methylene blue aqueous solution 76 at a wavelength of 665 nm, when applying ultraviolet light to the methylene blue aqueous solution 76;

FIG. 15 A graph showing an absorption spectrum of a nitrous oxide aqueous solution when ultraviolet light is applied;

FIG. 16 A graph showing a UV absorption spectrum of a nitrous oxide aqueous solution;

FIG. 17 A graph showing a UV absorption spectrum of oxygen molecules; and

FIG. 18 A schematic diagram showing a heretofore known wet etching method.

### DESCRIPTION OF REFERENCE NUMERALS AND SIGNS

1 Insulating substrate
2 Copper foil
3 Printed substrate
4 Receptacle
5 Solution
6 Supporting means
7, 19 Pattern
8, 20 Mask
9, 21 Ultraviolet light
10a, 10b, 22a, 22b Area
11 Glass substrate
12 Molybdenum film
13 Color filter substrate
14 Stage
15 Rotation axis
16 Aqueous solution
17 Nozzle
18 Film
23, 24, 25 Color filter film
30 Receptacle
31 Solution
32 Processing object
33 Supporting means
34a, 34d Light source
35a, 35d, 38a, 38d Ultraviolet light
36a, 36d Lens
37a, 37b, 37c, 37d Specified area
40 Receptacle
41, 67 Solution
42, 63 Processing object
43 Holder
44, 55, 72 Arm
45, 68 Light source
46, 69 Ultraviolet light
47, 70 Mask
48, 71 Pattern
49, 64 Tank
50 Liquid supply valve
52 Discharge pipe
53 Discharge valve
54, 73 Mask supporting means
60 Hood
61, 74 Rotation axis
62 Table
65 Liquid supply pipe
66 Nozzle

### BEST MODE FOR CARRYING OUT THE INVENTION

A description will be given of a first embodiment of a wet etching method according to the invention. Herein, a solution including nitrous oxide refers to a solution obtained by dissolving nitrous oxide gas in a solvent such as water. Firstly, a solution in which nitrous oxide has been dissolved is prepared. Next, a processing object and the solution are brought into contact. Then, an etching is carried out by applying ultraviolet light to an extreme vicinity of the solution which is in contact with the processing object, dissolving away the processing object.

A mechanism by which the etching is carried out can be understood as follows. On applying the ultraviolet light to the nitrous oxide dissolved in the solution, the nitrous oxide is dissociated into nitrogen (N₂) and oxygen (O). The dissociated oxygen has an extremely high oxidative power (this oxygen is called atomic oxygen). The atomic oxygen and matter of the processing object collide, oxidizing the matter. However, a diffusive transfer distance of the atomic oxygen in the solution is extremely small. For this reason, only matter in a specified area in an extreme vicinity of the generation of the atomic oxygen is oxidized. The oxide is dissolved in the solution, immediately upon its generation, by means of an interaction with the solution. In this way, a wet etching is performed by the processing object in the area to which the ultraviolet light is applied being dissolved away.

As a solution which dissolves the nitrous oxide in the embodiment, one which is capable of transmitting light with a wavelength of 240 nm or less is preferable. For example, it is possible to use any of water, methanol, ethanol, isopropanol, methylcyclohexane, cyclohexane, acetonitryl, hexane, dioxane, glycerine, n-pentane, or dichloromethane, or a solution including these. Among these, water is particularly preferable, as it has a high transmission capability around a wavelength of 190 nm.

It is preferable to make a concentration of the nitrous oxide in the embodiment 10 ppm to 5,000 ppm. Also, an ultraviolet light wavelength of 240 nm or less being desirable, an ultraviolet light which has an intensity spectrum in a range of 173 nm to 240 nm is preferable. As a source of the ultraviolet light, a mercury lamp or an excimer lamp can be used. This is because a wavelength at which the nitrous oxide is broken down into the atomic oxygen is a wavelength which is shorter than 240 nm.

Also, in the embodiment, in order to promote the dissolution of the oxide, it is desirable to add an acid or an alkali to the solution. As an acid, it is possible to make it a solution including any acid of, for example, sulfuric acid, phosphoric acid, hydrochloric acid, boric acid, carbonic acid, hydrofluoric acid, nitric acid, formic acid, or acetic acid, and also, as an alkali, it is possible to make it a solution including any alkali of, for example, ammonia, sodium hydroxide, potassium hydroxide, or tetramethylammonium hydroxide.

When selecting the acid or alkali to be added to the solution, it is advantageous in selectively etching an ultraviolet light application area to choose one with an extremely low property of dissolving the actual substance which is the object of the etching, and an extremely high property of dissolving the oxide of the substance which is the object. This is because in the event that, for example, an acid which, with respect to the object substance which is not the oxide, has a high property of dissolving the substance itself, is added to the solution, a dissolution proceeds even in a portion in which the oxide of the substance is not generated, and it becomes difficult to obtain an intended shape of etching.

As a processing object, it is possible to utilize a substance in which oxidization is promoted by means of the atomic oxygen. For example, it is possible to use one kind chosen from silicon, aluminium, copper, iron, zinc, titanium, tantalum, silver, zirconium, tungsten, chromium, molybdenum, nickel, hafnium, ruthenium, niobium, yttrium, scandium, neodymium, lanthanum, cerium, cobalt, vanadium, manganese, gallium, germanium, indium, tin, rhodium, palladium, cadmium, antimony, or an alloy including these.

In a second embodiment of the etching method according to the invention, it is possible to form a pattern on the processing object by, for example, providing a mask or the like, which intercepts the ultraviolet light, between the light source and the processing object. That is, on the ultraviolet light being applied to a vicinity of the processing object other than a portion blocked by the mask, only nitrous oxide in the area to which the ultraviolet light is applied is dissociated, generating the atomic oxygen. Then, an oxide film is formed by the atomic oxygen oxidizing a surface of the processing object. As the diffusive transfer distance of the atomic oxygen is extremely small, the atomic oxygen is unable to move as far as the area from which the ultraviolet light is blocked by the mask, because of which, no oxide film is generated by the atomic oxygen in the area from which the ultraviolet light is blocked by the mask. As a result of this, the surface of the processing object to which the ultraviolet light is applied is oxidized, the oxide film is generated, and the oxide film is dissolved and etched away by the solution.

By having a silicon substrate, and a molybdenum, aluminium or other conductor film formed on a surface of the silicon substrate, as a processing object, it is possible to pattern the silicon substrate surface and conductor film without using a photoresist. Also, by having a molybdenum, aluminium or other conductor film formed on a glass substrate, or the like, as a processing object, it is possible to form a conductor film pattern on an insulator. Also, by having a printed substrate configured of copper foil formed on an insulating substrate as a processing object, it is possible to carry out a patterning of the printed substrate without using a photosensitive film such as the photoresist.

In a third embodiment of the etching method according to the invention, it is possible to control a volume of, or depth to which, the processing object is dissolved away by controlling a time for which the ultraviolet light is applied. The atomic oxygen being dissociated when the ultraviolet light is applied, as no atomic oxygen is generated when the ultraviolet light is not applied, the etching of the processing object does not proceed. That is, by controlling the time for which the ultraviolet light is applied, it is possible to control the volume to be etched of the processing object, or the depth of the etching.

Furthermore, by locally applying the ultraviolet light to the solution, it is possible to locally process the surface of the processing object. For example, by collecting the ultraviolet light by means of a lens configured of a synthetic quartz lens and applying it to the processing object, it is possible to increase an optical intensity of the ultraviolet light, and it is possible to reduce an area of application to, for example, a micrometer order or less. In the event of using the silicon substrate as the processing object, it is possible to process a microscopic area on its surface to a predetermined depth.

Next, a description will be given of a first embodiment of a wet etching apparatus according to the invention. The wet etching apparatus according to the invention is a wet etching apparatus configured of contact means, which brings a solution in which nitrous oxide has been dissolved into contact with a processing object, and light application means, which applies ultraviolet light to the solution which is in contact with the processing object.

The contact means includes solution holding means, configured of a basket or the like, which holds the solution, and processing object holding means for immersing the processing object in the solution. The light application means includes a light source, configured of a mercury lamp or the like, which emits the ultraviolet light, and mask supporting means, which supports a light intercepting mask between the light source and the processing object holding means. The etching is carried out by supplying a solution composed of, for example, an aqueous solution in which the nitrous oxide has been dissolved to the solution holding means, and holding it; mounting, for example, a silicon substrate as the processing object on the processing object holding means, and immersing it in the solution; installing the light intercepting mask on the mask supporting means, and applying the ultraviolet light from the light source configured of the mercury lamp or the like.

In a wet etching apparatus which is a second embodiment of the invention, the contact means includes solution holding means, configured of a tank or the like, which holds the solution in which the nitrous oxide has been dissolved, solution supply means, configured of a nozzle or the like, which supplies the solution from the solution holding means to the processing object, and processing object holding means configured of a stage, rotatable by means of a motor or the like, on which the processing object is mounted. Then, the light application means includes the light source, configured of the mercury lamp or the like, which emits the ultraviolet light, and the mask supporting means, which supports the light intercepting mask between the light source and the processing object holding means.

The wet etching apparatus etches the processing object in the following way. In a case of carrying out an etching of the silicon substrate as the processing object, firstly, the silicon substrate is mounted on the rotating stage which is the processing object holding means. Next, the light intercepting mask, on which a pattern to be etched is drawn, is set on the mask supporting means. Then, the mercury lamp, which is the light source, and the mask are moved above the silicon substrate. Next, the solution in which the nitrous oxide has been dissolved is supplied from the nozzle to the silicon substrate by means of a method such as a dripping, a spraying or a jet. Next, the mercury lamp, which is the light source, is turned on, and the ultraviolet light is applied to a surface of the silicon substrate. As a result thereof, an area of the silicon substrate to which the ultraviolet light is applied is etched, while an area of the silicon substrate from which the ultraviolet light is blocked by the mask is not etched, or barely etched. In this way, it is possible to transfer the pattern of the mask to the surface of the silicon substrate.

As the nitrous oxide in the solution is consumed by the etching process, it is possible, when necessary, to supply the solution from the nozzle, intermittently or continuously, by means of a controller. After the etching process is completed, the rotating stage is rotated, the solution is removed from the surface and the silicon substrate moved from the rotating stage, and a next silicon substrate is set on the rotating stage.

Hereafter, a more specific description will be given, referring to the drawings, of the embodiments of each of the wet etching method and wet etching apparatus according to the invention.

### Embodiment 1 of Wet Etching Method

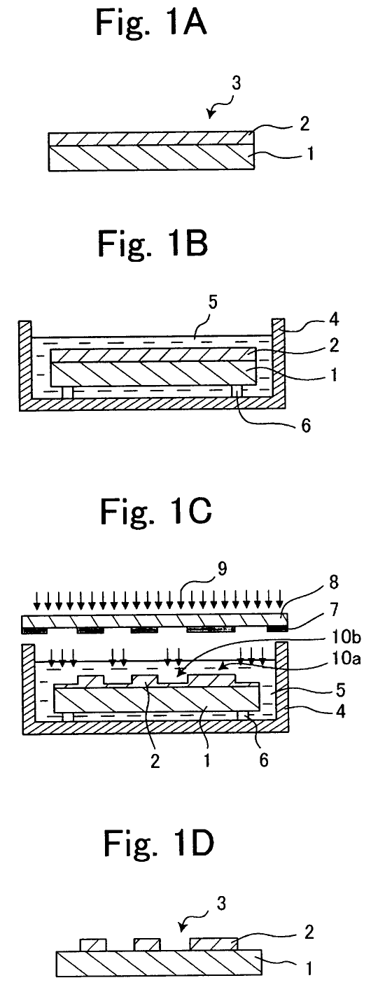

A description will be given of a wet etching method according to the first embodiment of the invention, while referring to FIG. 1.

FIG. 1 shows a method of forming a pattern on a printed substrate 3, configured of copper foil 2 laminated on an insulating substrate 1. Firstly, as shown in FIG. 1(a), the printed substrate 3, configured of the copper foil 2 formed on the insulating substrate 1, is prepared. The processing object in this case is the copper foil 2. Before carrying out an etching, a process of immersing in a 5% copper sulfate aqueous solution for one minute is carried out, after which a process of further soaking in pure water for one minute is carried out, completely dissolving away an extremely small amount of copper oxide (CuO) naturally generated on a surface of the copper foil 2 (hereafter, this process is called a preprocessing). As a result of this, the surface of the copper foil 2 becomes only metallic Cu and Cu₂O.

Next, as shown in FIG. 1(b), a sulfuric acid aqueous solution 5, which is a solution in which nitrous oxide is dissolved, is supplied to a receptacle 4, the printed substrate 3 is immersed therein, and installed on supporting means 6.

Next, as shown in FIG. 1(c), a mask 8 on which is formed a pattern 7, configured of a chromium film, or the like, which is a light blocking material, is disposed above the receptacle 4, and ultraviolet light 9 is applied from a light source, which is configured of a high pressure mercury lamp. In order to transfer the pattern 7 formed on the mask 8 at a reduction ratio of one to one, it is desirable that the ultraviolet light 9 is configured of parallel rays. Also, it is also possible to carry out a projection type of exposure. In this case, it is arranged in such a way that a lens system is provided between the light source and the printed substrate 3, which is the processing object, enlarging or reducing the pattern 7 of the mask 8, and forming an image on the surface of the printed substrate 3. By so doing, it is possible to enlarge or reduce the pattern 7 formed on the mask 8.

By applying the ultraviolet light 9 to the printed substrate 3, atomic oxygen dissociated from the nitrous oxide is generated in a vicinity of the copper foil 2 in an area 10b to which the light is applied, the copper foil 2 is oxidized into copper oxide, and the copper oxide is dissolved away by the sulfuric acid aqueous solution. In an area 10a to which the ultraviolet light 9 is not applied, as no atomic oxygen is generated, and the sulfuric acid aqueous solution 5 does not dissolve the Cu and Cu₂O, no etching is carried out either. FIG. 1(c) shows a condition in which the copper foil 2 is in the process of being etched.

FIG. 1(d) shows a cross-section of the printed substrate 3, to which the ultraviolet light 9 has been applied, etching until the copper foil 2 in the area 10b exposes the insulating substrate 1, and which has been removed from the sulfuric acid aqueous solution 5.

In the heretofore described embodiment, the high pressure mercury lamp is used as the light source, but it is possible to use a low pressure mercury lamp instead. Also, it is also possible to use an electrolytic coupling type high frequency discharge lamp (called an excimer lamp) as the light source. The excimer lamp, in which xenon is enclosed, emits ultraviolet light centered around a wavelength of 172 nm. In the event that the ultraviolet light with the wavelength of 172 nm is used in the atmosphere, as well as causing ozone to be emitted, it is easily absorbed by the atmosphere. Consequently, it is preferable to replace the atmosphere of the light source and an area through which the ultraviolet light passes with nitrogen gas or the like. The ultraviolet light of the excimer lamp in which xenon is enclosed also has a characteristic that a transmittance in an aqueous solution is low. Therein, it is possible to use an excimer lamp in which krypton and iodine are enclosed as the light source. An emission wavelength of this excimer lamp being 191 nm, it is more suited to a dissolution of nitrous oxide.

Also, although the sulfuric acid aqueous solution is used as the solution in the heretofore described embodiment, it is possible to use a phosphoric acid aqueous solution instead. In the etching method according to the invention, it is desirable that the copper foil 2 does not dissolve in the area 10a, to which the ultraviolet light is not applied. However, as long as an amount of the copper foil 2 which dissolves in the area 10b, to which the ultraviolet light is applied, is greater than an amount of the copper foil 2 which dissolves in the area 10a, to which the ultraviolet light is not applied, it is possible to carry out a patterning of the copper foil 2. That is, the greater a difference in an etching rate between the area to which the ultraviolet light is applied and the area to which it is not applied, the easier the patterning of the copper foil 2 becomes. It has been confirmed that the phosphoric acid aqueous solution satisfies this condition.

Next, a description will be given of a field emission type emission electron element wet etching method used in a field emission source or the like of an FED (Field Emission Display), using the heretofore described first embodiment.

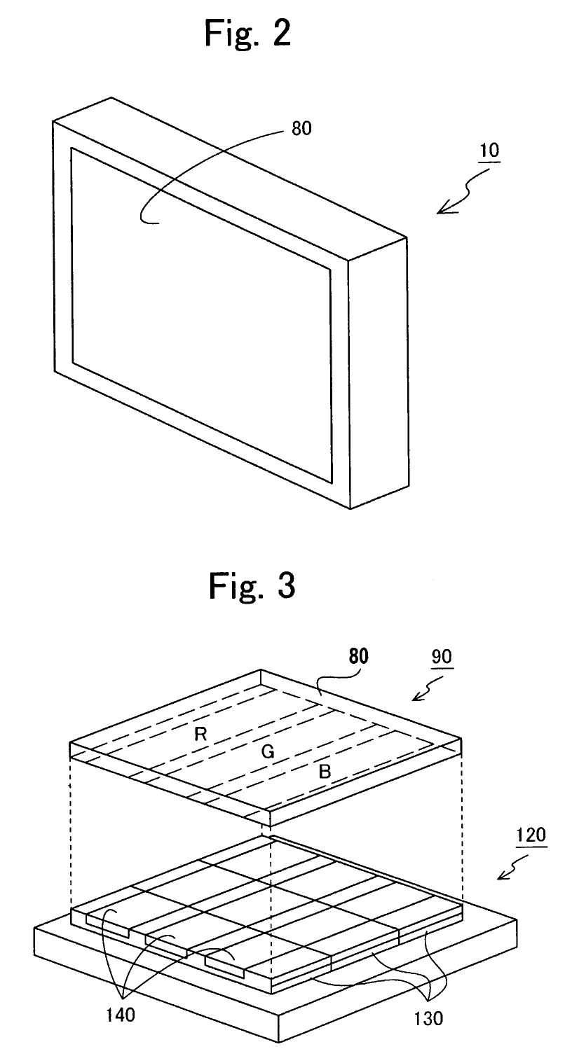

A description will be given of the field emission type emission electron element (hereafter, also abbreviated to the “FE element”), using FIGS. 2 and 3. FIG. 2 is a view of the FE element disposed in such a way that a display surface 80, to be described hereafter, is positioned in the front, while FIG. 3 is a view of the FE element disposed in such a way that the display surface 80 is positioned at the top.

The FE element, as shown in FIG. 2, is used in a flat type display device 10, which has the display surface 80 which displays an image.

One portion of the FED, as shown in FIG. 3, includes an anode panel 90, which has the display surface 80, and a cathode panel 120 positioned in a direction opposite to that of the display surface 80. The anode panel 90 and cathode panel 120 are sealed in such a way that a space between them is in a vacuum condition.

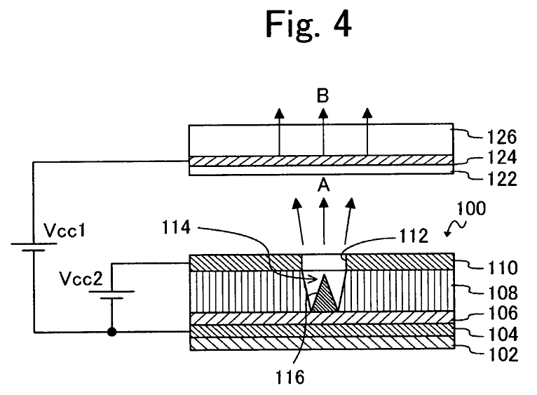

Although a detailed description will be given hereafter, electrons are emitted toward the anode panel 90 from an emitter electrode 116 (refer to FIG. 4) formed on the cathode panel 120. Also, the anode panel 90 is segregated into colors RGB. Also, an amount of luminescence from the display surface 80 varies depending on an amount of electrons emitted from the emitter electrode 116. On account of this, an emission of the RGB being carried out to a predetermined amount of luminescence, various kinds of image are displayed.

Also, cathode electrode lines 130 forming a cathode electrode 104 (refer to FIG. 4), to be described hereafter, and gate electrode lines 140 forming a gate electrode 110 (refer to FIG. 4) are laminated on the cathode panel 120 in such a way as to intersect.

A description will be given of a configuration of the FE element in the embodiment, using FIG. 4. A sectional view shown in FIG. 4 is a sectional view in a place where the cathode electrode lines 130 and the gate electrode lines 140 intersect via an insulating layer 108.

In the FE element 100, as shown in FIG. 4, the cathode electrode 104, a resistive layer 106, the insulating layer 108, and the gate electrode 110 are laminated in order on a supporting body 102.

As a material of the supporting body 102, it is possible to use, for example, as well as anon-alkali glass, a low-alkali glass, an alkali glass, a quartz glass or the like, a ceramic material such as an alumina, or furthermore, a plastic film or the like, on a surface of which a protective layer is provided, such as a polyethylene terephthalate film, a polyethylene-2, a 6-naphthalate film, a polycarbonate film, a polysulfone film, a polyether sulfone film, a polyether ether ketone film, a polyphenoxy ether film, or a polyarylate film.

As a material of the cathode electrode 104 and the gate electrode 110, a metal which oxidizes and forms a stable passivity on a metal film surface being appropriate in order to improve an etching selectivity compared with the electron emission material at a time of an etching of unnecessary electron emission material 118, as a specific example, it is appropriate to use chromium (Cr), aluminium (Al), tantalum (Ta), titanium (Ti), niobium (Nb), or a metal composed of an alloy which has one of these as a main element.

As a material of the insulating layer 108, it is possible to use silicon oxide, silicon nitride or the like.

A metal which forms a water-soluble oxyacid by oxidizing being appropriate as an electron emission material configuring the emitter electrode 116 and the like, in order to improve the etching selectivity compared with the electron emission material at the time of the etching of the unnecessary electron emission material 118, to be described hereafter, as a specific example, molybdenum (Mo), tungsten (W), or the like, is appropriate.

Also, a cavity 114 is formed in the insulating layer 108, and an aperture 112 is formed in the gate electrode 110. The conical emitter electrode 116 is formed inside the cavity 114. The aperture 112 and cavity 114 are formed in a place where the cathode electrode lines 130 and the gate electrode lines 140 intersect.

Meanwhile, a fluorescent body 122, an anode electrode 124, and a glass substrate 126 are disposed in such a way as to oppose a leading extremity of the emitter electrode 116. Also, this kind of FE element 100 is sealed in such a way that a space between the emitter electrode 116 and the fluorescent body 122 is in a vacuum condition.

Then, by applying a voltage (specifically, represented by a reference numeral V_{cc}2 in FIG. 4) between the cathode electrode 104 and the gate electrode 110, as well as applying a voltage (specifically, represented by a reference numeral V_{cc}1 in FIG. 4) between the cathode electrode 104 and the anode electrode 124, electrons are emitted from the leading extremity of the emitter electrode 116 toward the anode electrode 124 (for example, represented by arrows A in FIG. 4), causing light to pass through to a glass substrate 126 side (for example, represented by arrows B in FIG. 4).

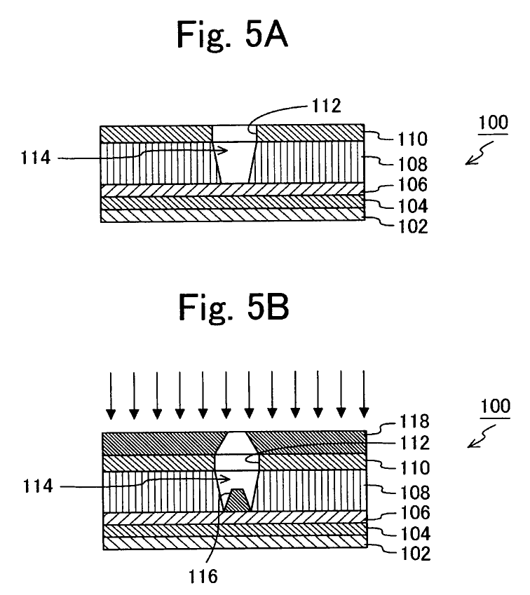

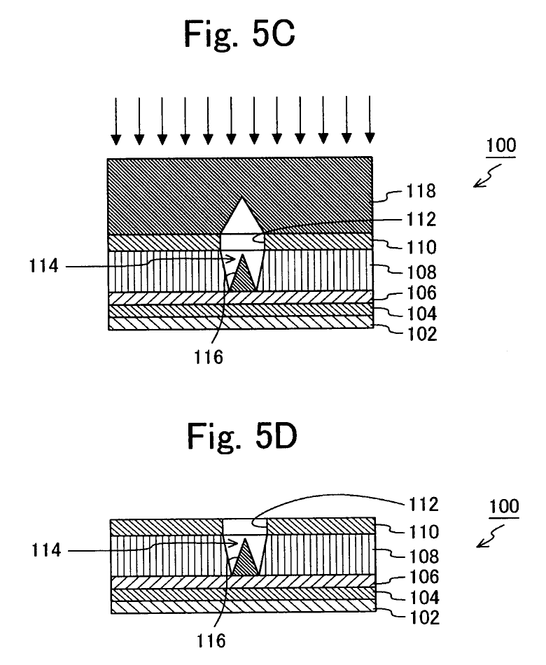

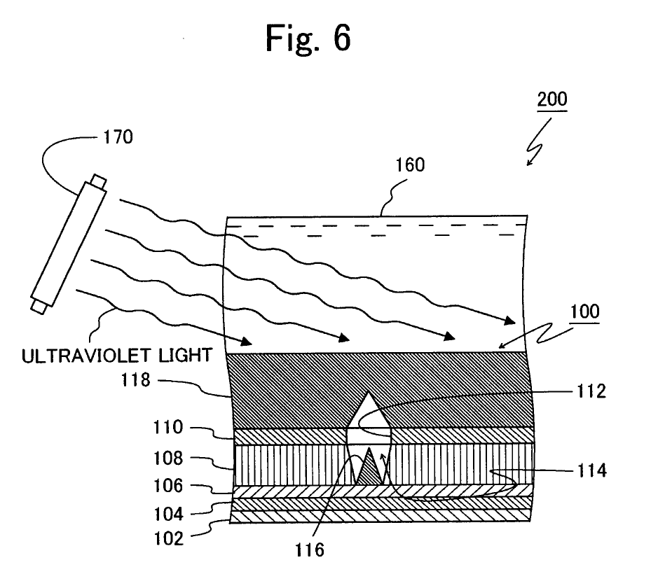

A description will be given of a manufacturing method of the FE element 100 configured in the way heretofore described, using FIGS. 5 and 6.

When manufacturing the FE element 100 with this kind of configuration, firstly, after forming a metal film which composes the cathode electrode 104 over a whole of one surface of the supporting body 102, a plurality of rows of cathode electrode lines 130 are formed by patterning the metal film.

Then, the resistive layer 106 is laminated on the cathode electrode lines 130. Then, the insulating layer 108 is laminated from a resistive layer 106 side.

Furthermore, after forming a metal film which composes the gate electrode 110 from an insulating layer 108 side, a plurality of rows of gate electrode lines 140 are formed by patterning the metal film. Also, this plurality of rows of gate electrode lines 140 are formed of a metal which does not become water-soluble, even when reacting with the heretofore described oxidizing agent. The cathode electrode lines 130 and the gate electrode lines 140 are disposed in a matrix formation.

Then, at the place where the cathode electrode lines 130 and the gate electrode lines 140 intersect, the cavity 114 is formed in the insulating layer 108, and the aperture 112 is formed in the gate electrode 110.

By this means, as shown in FIG. 5(A), the cathode electrode 104, the resistive layer 106, the insulating layer 108, and the gate electrode 110 being laminated in order on the supporting body 102, the cavity 114 is formed in the insulating layer 108, and the aperture 112 is formed in the gate electrode 110.

Continuing, as shown in FIG. 5(B), the electron emission material is deposited from a gate electrode 110 side. At this time, as the electron emission material also spreads in a lateral direction in the aperture 112 of the gate electrode 110, along with an accumulation of the unnecessary electron emission material 118, an opening formed by the aperture 112 becomes gradually smaller, ultimately being completely closed. As a result of this, the conical emitter electrode 116 is formed, in accordance with a contraction of the opening over the gate electrode 110, inside the cavity 114 of the insulating layer 108. By causing the electron emission material to accumulate in this way, as shown in FIG. 5(C), along with the conical emitter electrode 116 being formed inside the aperture 112, a residue of the unnecessary electron emission material 118 accumulates on a surface of the gate electrode 110. Also, the electron emission material is the heretofore described metal which forms a water-soluble oxide by oxidizing.

Then, the FE element 100, as shown in FIG. 6, is etched by a wet etching apparatus 200, to be described hereafter.

Specifically, the heretofore described solution 160, in which nitrous oxide has been dissolved, is stocked in a barrel. Then, the FE element 100 is immersed in the solution 160 in such a way as to bring the unnecessary electron emission material 118 into contact with the solution 160. Then, by applying ultraviolet light by means of an excimer lamp 170, which is a light source, the unnecessary electron emission material 118 is dissolved away.

At this time, by applying the ultraviolet light from an angle, or the like, contriving in such a way that the ultraviolet light is not applied to a vicinity of the emitter electrode, as long as the ultraviolet light is applied only to a vicinity of the unnecessary electron emission material on the gate electrode, it is possible to etch only an area to which the ultraviolet light is applied, that is, the unnecessary electron emission material on the gate electrode.

As the solution 160, although it is possible to use one which is capable of transmitting light with a wavelength of 240 nm or less, when considering a manufacturing cost, it is preferable to use an aqueous solution. An ultraviolet light wavelength of 240 nm or less being desirable, an ultraviolet light which has an intensity spectrum in a range of 173 nm to 240 nm is desirable. This is because a wavelength at which nitrous oxide dissociates into atomic oxygen being a wavelength which is shorter than 240 nm, and a wavelength of 167 nm being a maximum for an absorbance of water, the light applied to the aqueous solution must be of a wavelength shorter than 240 nm, and of a wavelength longer than a wavelength at which the absorbance of water is sufficiently small. Among these, by using ultraviolet light with a wavelength around 190 nm, it is possible to obtain an optimum oxidizing ability.

In the etching of the unnecessary electron emission material 118, in order to promote the dissolution of the oxidized electron emission material, it is desirable to add an alkali to the solution.

When selecting the alkali to be added to the solution, it is advantageous in selectively etching the ultraviolet light application area to choose one with an extremely low property of dissolving the unoxidized electron emission material itself, and an extremely high property of dissolving the oxide of the electron emission material. This is because in the event that, for example, an alkali which, with respect to the electron emission material which is not the oxide, has a high property of dissolving the electron emission material itself, is added to the solution, a dissolution proceeds even in a portion in which the oxide is not generated, that is, the emitter electrode, and it becomes difficult to obtain an intended emitter electrode shape. Because of this, as the alkali, it is preferable to make it a solution including any alkali of ammonia, sodium hydroxide, potassium hydroxide, or tetramethylammonium hydroxide.

Also, as heretofore described, by means of a combination of the material of the gate electrode 110 and the electron emission material, a difference is provided between oxidization and dissolution speeds of the gate electrode 110 and the unnecessary electron emission material 118. Consequently, along with inhibiting the dissolution of the gate electrode 110, the unnecessary electron emission material 118 is dissolved and removed.

By this means, as shown in FIG. 5(D), the electron emission material 118 accumulated on the surface of the gate electrode 110 is removed.

Continuing, sealing is done in such a way that the space between the anode panel 90 and the cathode panel 120 is in a vacuum condition.

By this means, by etching the unnecessary electron emission material 118, it is possible to manufacture a good FE element 100.

Next, a description will be given of a silicon substrate wet etching method used in a formation of a transistor, an LSI or the like, using the heretofore described first embodiment. A wet etching procedure is the same as the one illustrated in FIG. 1.

Firstly, a preliminary washing of a surface of the silicon substrate is carried out with hydrofluoric acid, removing an oxide film from the surface. Next, the silicon substrate is immersed in a hydrofluoric acid aqueous solution, in which nitrous oxide has been dissolved. Next, a light intercepting mask on which a pattern is formed by, for example, a chromium film or the like, being interposed between the light source and the silicon substrate, ultraviolet light is emitted from the light source, and applied to the silicon substrate. As a result of this, an area of a surface of the silicon substrate to which the ultraviolet light is applied being etched, and an area of the silicon substrate to which the ultraviolet light is not applied not being etched, it is possible to form the pattern formed on the mask on the surface of the silicon substrate. It can be supposed that the nitrous oxide included in the aqueous solution in the area to which the ultraviolet light is applied dissociates, atomic oxygen is generated, the silicon substrate in an extreme vicinity of the dissociated atomic oxygen is oxidized, silicon oxide is generated, and the silicon oxide is dissolved in the hydrofluoric acid aqueous solution.

### Embodiment 2 of Wet Etching Method

Next, a description will be given of a wet etching method which forms a liquid crystal color filter black matrix by means of a molybdenum (Mo) film, using the second embodiment.

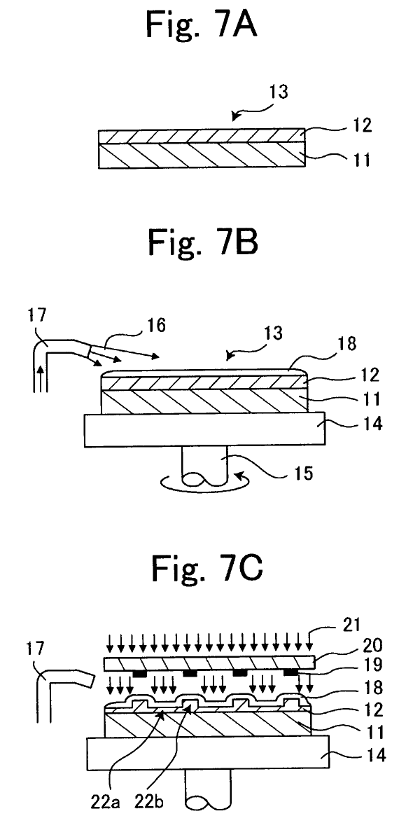

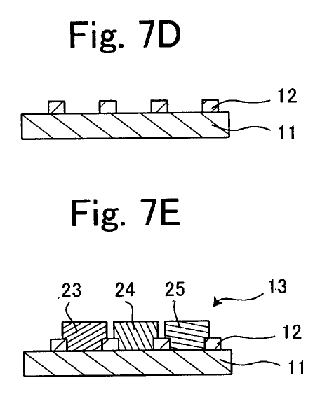

FIG. 7(a) is a schematic sectional view showing a condition in which a molybdenum film for a black matrix is formed on a color filter glass substrate 11.

Firstly, an opaque molybdenum film 12 is accumulated, by means of spattering, in a visible light range on the alkali free glass substrate 11. It is possible to make the molybdenum film 12 an alloy including nickel (Ni), iron (Fe) or the like.

Next, as shown in FIG. 7(b), a color filter substrate 13 is mounted on a rotatable stage 14 which is coupled to a rotation shaft 15. Then, using an aqueous solution 16 in which nitrous oxide and ammonia are dissolved as a solution, the solution is supplied to a surface of the molybdenum film 12 by jetting from a nozzle 17, and a film 18, including the aqueous solution 16, is formed on the molybdenum film 12.

Next, as shown in FIG. 7(c), a light intercepting mask 20, on which is formed a mesh formation pattern 19 made from a chromium film or the like, is approximated to the glass substrate 11, and ultraviolet light 21 is applied from above. Using a mercury lamp as a source of the ultraviolet light 21, it is arranged in such a way that parallel rays are applied by means of an unshown lens or the like. The molybdenum film 12 is etched in an area 22a to which the ultraviolet light 21 is applied, but not etched in an area 22b to which the ultraviolet light 21 is not applied.

As the etching proceeds, the nitrous oxide and ammonia in the aqueous solution are consumed. Therein, it is possible to interrupt the application of the ultraviolet light 21, supply the aqueous solution 16 from the nozzle 17, and again carry out the application of the ultraviolet light 21. When supplying the aqueous solution 16, in order to avoid the aqueous solution in which the nitrous oxide and ammonia have been consumed and the newly supplied aqueous solution mixing, and a concentration distribution of the nitrous oxide and ammonia occurring, it is preferable to rotate the stage 14, removing the used aqueous solution, before supplying the new aqueous solution 16.

FIG. 7(d) is a schematic sectional view showing a condition in which the molybdenum film 12 is etched until the underlying glass substrate 11 is exposed. The pattern 19 formed on the mask 20 is transferred to the molybdenum film 12. Planarly, the molybdenum film 12 is patterned in the mesh formation.

FIG. 7(e) is a schematic sectional view showing a condition in which color filter films 23, 24 and 25 of R (red), G (green) and B (blue) are formed on the glass substrate 11. The color filter films can be compiled by forming a polyimide film on the glass substrate 11 and molybdenum film 12, and impregnating with RGB dyes. Alternatively, it is possible to form the color filters by sequentially patterning a polyimide film on which pigments having RGB colors are mixed. The molybdenum film 12 is disposed in gaps between the color filters, arranging in such a way that no light escapes from the gaps. By so doing, it is possible to increase a color purity of the color filters.

In the above description, a description has been given of the wet etching method in the case of using the molybdenum film 12 as a color filter light intercepting film, but it is also possible to pattern in the same way for a molybdenum film formed on a silicon substrate. Also, in the above description, a description has been given of the method of etching by jetting an aqueous solution in which nitrous oxide is dissolved from a nozzle but, instead, as illustrated in FIG. 1, it is possible to carry out the etching by immersing the color filter substrate 13 in an aqueous solution, providing a mask between the same color filter 13 and a light source, and applying ultraviolet light.

### Embodiment 3 of Wet Etching Method

Next, a description will be given of the wet etching method, which is the third embodiment, which etches a local area by applying ultraviolet light restricted to the local area by means of optical path adjustment means.

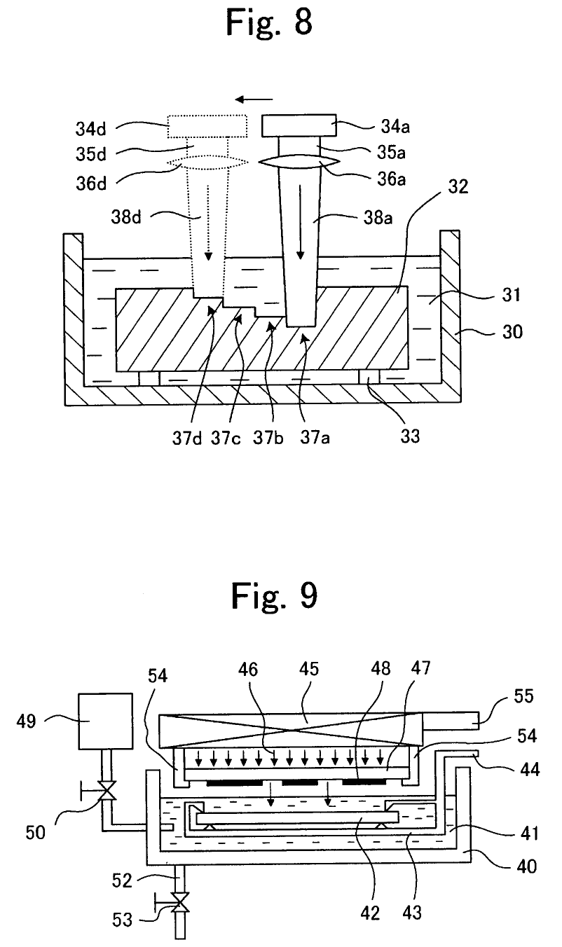

FIG. 8 is a conceptual diagram which shows a wet etching method which etches a specified area from 37a to 37d of a processing object 32.

With this wet etching method, an etching proceeds by ultraviolet light 38a being applied, but the etching does not proceed in the event that the ultraviolet light is blocked. Alternatively, an area to which the ultraviolet light 38a is applied is etched more than an area to which it is not applied. Utilizing this property, by constricting the ultraviolet light 38a into a specified range and operating it, it is a method wherein, as it were, the processing object 32 is processed using the ultraviolet light 38a as a knife.

As shown in FIG. 8, a solution 31 in which nitrous oxide is dissolved is held in a receptacle 30, the processing object 32 is immersed in the solution 31, ultraviolet light 35a is applied from a light source 34a disposed overhead, an application area of the ultraviolet light 38a is constricted by a lens 36a, which is optical path adjustment means, and the specified area 37a of the processing object 32, mounted on supporting means 33, is etched. In this case, it is possible to use a copper or silicon substrate, or another material, as the processing object 32, and it is possible to use a sulfuric acid aqueous solution, a hydrofluoric acid aqueous solution or the like as the solution 31. Also, an ultrahigh pressure mercury lamp is used as the light source 34a, and a synthetic quartz glass with a high ultraviolet light transmittance is used for the lens 36a which acts as the optical path adjustment means.

The ultraviolet light 35a is constricted to the specified range 37a, and applied for a predetermined time. Next, the light source 34a and the lens 36a are moved in a direction of an arrow, etching next specified areas 37b, 37c and 37d, and stopped in positions of a light source 34d, ultraviolet light 35d, a lens 36d, and collected ultraviolet light 38d. In this case, an application time is made progressively shorter than for the specified area 37a. For this reason, a depth to which etching is done becomes progressively less. In this way, it is possible to form a desired shape of graduated depths on a surface of the processing object 32.

It is possible to constrict the ultraviolet light 35a with the lens 36a to, for example, a micrometer order. That is, by collecting the ultraviolet light 35a, it is possible to make a strength of the ultraviolet light 38a extremely high in a microscopic area, and apply it to the processing object 32. By collecting the light in this way, it is possible to etch away a necessary volume of an area of, or smaller than, a micrometer order. This method can be applied to a microelectromechanical system (MEMS) technology or the like.

### Embodiment 1 of Wet Etching Apparatus

Next, a description will be given of the first embodiment of the wet etching apparatus according to the invention.

FIG. 9 is a conceptual diagram of a wet etching apparatus which carries out a wet etching immersing a processing object in a solution in which nitrous oxide is dissolved.

With the wet etching apparatus, a receptacle 40, which is solution holding means, is provided, and a solution 41 in which nitrous oxide is dissolved is held in the receptacle 40. Providing a tank 49 which holds the solution, the solution is supplied as appropriate to the receptacle 40 by means of a liquid supply valve 50. Also, a discharge pipe 52 for discharging used solution 41 is provided. A holder 43, which is processing object holding means for holding a processing object 42 and immersing it in the solution 41, and an arm 44 constructed integrally with the holder 43, are provided. The arm 44 is attached to an unshown moving mechanism. The moving mechanism can install the processing object 42 in the holder 43 from an unshown processing object storage portion on an exterior of the receptacle 40. It is possible to cause the holder 43 and processing object 42 to move, by means of the unshown moving mechanism, in such a way as to be immersed in the solution 41 of the receptacle 40. A light source 45, which is light application means, and mask supporting means 54 which supports a light intercepting mask 47, on which is formed a pattern 48, below the light source 45, are integrally configured. The light source 45 and mask 47 are held by an arm 55. The arm 55 being connected to an unshown starting mechanism, after the processing object 42 has been immersed in the solution 41 along with the holder 43, it is driven in such a way as to move the light source 45 and mask 47 to a position above the receptacle 40.

The wet etching apparatus being equipped with a control mechanism, it can carry out the heretofore described series of operations automatically. For the replacement of the solution 41, the control mechanism, after etching a predetermined quantity of processing substrates, automatically opens a discharge valve 53 installed in the discharge pipe 52, disposes of the solution and, after closing the discharge valve 53, opens the liquid supply valve 50, supplying the solution 41 to the receptacle 40 from the tank 49. After the solution 41 has been supplied, the control mechanism installs the processing object 42 in the holder 43 and, moving it by means of the arm 44, immerses the processing object 42 in the solution 41 of the receptacle 40. Next, after moving the light source 45, and the mask 47 which is installed by means of the mask supporting means 54, to a position above the receptacle 40 by means of the moving mechanism connected to the arm 55, the control mechanism causes the light source 45 to emit light for a predetermined time, applying the ultraviolet light 46 and etching the processing object 42. Next, the control mechanism moves the light source 45 and mask 47 from above the receptacle 40, lifts the arm 44 upward by means of the drive mechanism, moving it to the processing object 42 of the storage portion, removes the processing object 42 from the holder 43, and stores it in the storage portion.

Firstly, a control mechanism mounts a processing object 63 on a table 62 by means of an unshown drive mechanism. A substrate adsorption mechanism being configured on an upper surface of the table 62, it enables, for example, a vacuum adsorption. Next, the control mechanism causes a nozzle 66 to rotate with a liquid supply pipe 65 as a rotation shaft, and moves it to a predetermined position above the table 62. Next, the control mechanism jets a solution 67 from a tank 64, and causes it to remain on a surface of the processing object 63. Next, the control mechanism causes a light source 68, on which a mask 70 is installed, to rotate centered on a rotation axis 74, moves it to a determined position over the table 62, turns on the light source 68, and applies ultraviolet light 69. Depending on an amount of etching of the processing object 63, the control mechanism turns off the light source 68, and supplies a solution 67 from a tank 64 via the nozzle 66. After an etching is finished, the control mechanism rotates and moves the nozzle 66, removing it from above the table 62, and next, rotates the light source 68 and mask 70, centered on the rotation axis 74, by means of an unshown drive mechanism, and removes them from above the table 62. Next, the control mechanism removes the processing object from the table 62.

Next, a description will be given of a wet etching apparatus used in a manufacture of an FE element using the embodiment.

A description will be given, using FIG. 6, of the wet etching apparatus 200, which is one example of a wet etching apparatus for mainly etching electron emission material accumulated to excess when forming the emitter electrode 116. In FIG. 6, it being a view for illustrating one FE element 100, a description of another FE element is omitted in order to facilitate an understanding.

The wet etching apparatus 200 is mainly an apparatus which dissolves and removes the unnecessary electron emission material 118 in the FE element 100.

The wet etching apparatus 200 is configured of contact means which, after the solution 160 is stocked in the barrel, brings the solution 160 into contact with the unnecessary electron emission material 118 accumulated on a gate insulating film by immersing the FE element 100 in the solution 160, the excimer lamp 170 acting as application means which applies ultraviolet light to the solution 160, and the like.

The excimer lamp 170 is for carrying out an etching process on the immersed FE element 100 by applying ultraviolet light to the solution 160 which is in contact with a surface of the FE element 100, causing nitrous oxide to dissolve in the solution 160, and oxygen atoms to be produced.

The excimer lamp 170 is installed in a position, mainly diagonally above the FE element 100, from which it applies ultraviolet light only to the unnecessary electron emission material 118, without applying it to the emitter electrode 116. As the emitter electrode 116 is formed inside the cavity 114, the installation position of the excimer lamp 170 is such as to, by causing the ultraviolet light to fall diagonally incident on the FE element 100, making the gate electrode 110 and the insulating layer 108 an ultraviolet light shielding wall, prevent an application of the ultraviolet light to the solution 160 which is in contact with the emitter electrode 116. An angle of incidence of the ultraviolet light on the FE element 100, determined by a positional relationship between the excimer lamp 170 and the FE element 100, is determined by a relationship between a height of the gate electrode 110 from the resistive layer 106, a diameter of the aperture 112 formed in the gate electrode 110, and furthermore a height of the emitter electrode 116.

The wet etching apparatus 200 according to the embodiment is a wet etching apparatus configured of contact means which brings the solution 160, in which nitrous oxide is dissolved, into contact with the FE element 100, and light application means which applies ultraviolet light to the solution 160 which is in contact with the FE element 100.

The contact means, as with the heretofore described wet etching apparatus 200, has solution holding means including a barrel, or the like, which holds the solution 160, and FE element holding means for immersing the FE element 100 in the solution 160. The light application means, in order to adjust an angle of incidence of the ultraviolet light on the FE element, has a light source including an excimer lamp 170, or the like, which emits ultraviolet light, and a position adjustment mechanism for the light source and the FE element holding means. An etching is carried out by supplying the solution 160, including, for example, an aqueous solution in which nitrous oxide is dissolved, to the solution holding means and holding it, mounting the FE element 100 on the FE element holding means and immersing it in the solution 160, adjusting the angle of incidence of the ultraviolet light on the FE element 100, and applying ultraviolet light from the light source including the excimer lamp 170 or the like.

### Embodiment 2 of Wet Etching Apparatus

Next, a description will be given of the wet etching apparatus which is the second embodiment.

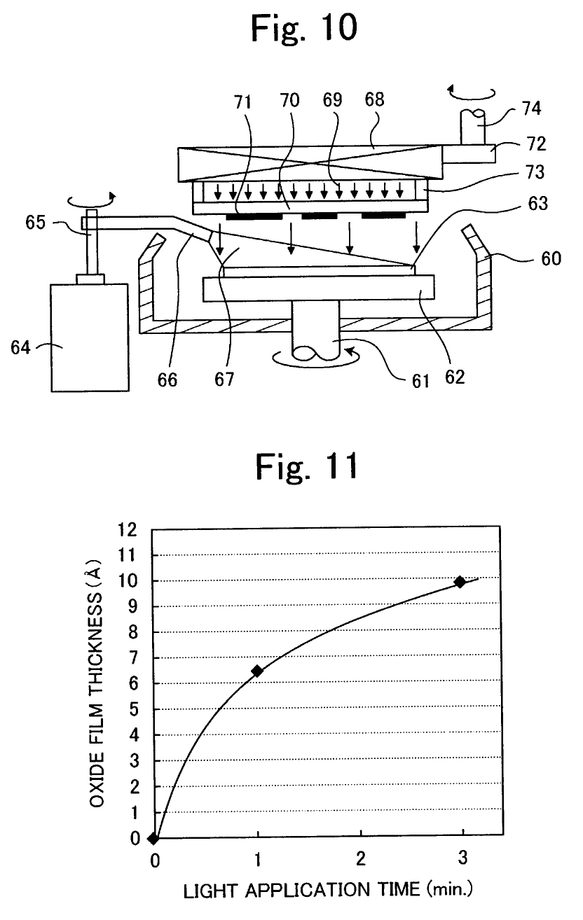

FIG. 10 is a conceptual diagram of a wet etching apparatus which supplies the solution 67, in which nitrous oxide is dissolved, to the processing object 63 by jetting it by means of the nozzle 66.

The table 62, which is processing object holding means which holds the processing object 63, a rotation shaft 61 which rotatably holds the table and, around the table, a hood 60 for preventing a splashing of the solution 67 to an exterior, are provided. The tank 64, which is solution holding means which holds the solution 67, in which nitrous oxide is dissolved, for etching the processing object 63, and the nozzle 66 for jetting the solution 67 from the tank 64, being furnished, the liquid supply pipe 65 which supports the nozzle 66 is rotatably attached. The light source 68, and mask support means 73 which supports the mask 70, are integrally configured above the table 62. The light source 68 and mask 70 are held by the rotation shaft 74, which rotatably supports an arm 72. It is possible to rotate and move the light source 68, and the mask 70 on which a light blocking pattern 71 is formed, to a position above the table 62 by means of an unshown drive mechanism.

The wet etching apparatus is configured in such a way as to be able to automatically carry out a wet etching by means of an unshown control mechanism.

Next, a description will be given of a wet etching apparatus used in an FE emission element manufacturing method using the embodiment. The wet etching apparatus has contact means, which brings the solution 160 into contact with the unnecessary electron emission material 118 accumulated on the gate insulating film, and application means which applies ultraviolet light to the solution 160. The contact means has solution holding means including a tank, or the like, which holds the solution 160 in which nitrous oxide is dissolved, solution supply means including a nozzle, or the like, which supplies the solution 160 to the FE element 100 from the solution holding means, and FE element holding means including a stage rotatable by a motor, or the like, on which the FE element 100 is mounted. Then, the light application means has a light source including the excimer lamp 170, or the like, which emits ultraviolet light, and a position adjustment mechanism for the light source and the FE element holding means.

The wet etching apparatus etches the FE element 100 in the following way. Firstly, the control mechanism adjusts a positional relationship of the excimer lamp 170, which is the light source, and the FE element holding means. Next, the control mechanism mounts the FE element 100 on a roller, which is the FE element holding means, and starts a movement. Next, the control mechanism supplies the solution 160 in which nitrous oxide is dissolved to the FE element 100 which has moved, by means of a method such as a dripping, a spraying or a jet. Next, the control mechanism turns on the excimer lamp 170, which is the light source, and applies ultraviolet light to a surface of the FE element 100 which has moved. As a result of this, the unnecessary electron emission material 118 to which the ultraviolet light is applied is etched, while the emitter electrode in an area from which the ultraviolet light is blocked is not etched, or barely etched. In this way, it is possible to remove the unnecessary electron emission material 118 on the FE element 100.

As the nitrous oxide in the solution 160 is consumed by the etching process, it is possible, when necessary, to supply the solution 160 from the nozzle, intermittently or continuously, from the nozzle by means of a control apparatus. After the etching process is completed, the control mechanism removes the solution 160 from the surface of the FE element 100 by causing the rotating stage to rotate, or by using an air shower.

Next, a description will be given of an oxidization of a substance by ultraviolet light, which is a basic feature of the wet etching method of the invention.

The wet etching method according to the invention is one in which an etching is carried out by oxidizing a processing substance at a time of a wet etching, generating an oxide, and dissolving away the oxide. Therein, a description will be given, based on an experiment result, of the oxidization of the processing material being promoted by applying ultraviolet light to an aqueous solution in which nitrous oxide is dissolved, and of the fact that when the application of the ultraviolet light is stopped, the oxidization also stops.

FIG. 11 is a graph showing a relationship between a light application time and a thickness of a silicon oxide film when immersing a silicon substrate in the aqueous solution in which nitrous oxide is dissolved, and applying ultraviolet light, causing a formation of a silicon oxide film. A horizontal axis shows the ultraviolet light application time, and a vertical axis shows the thickness of the silicon oxide film.

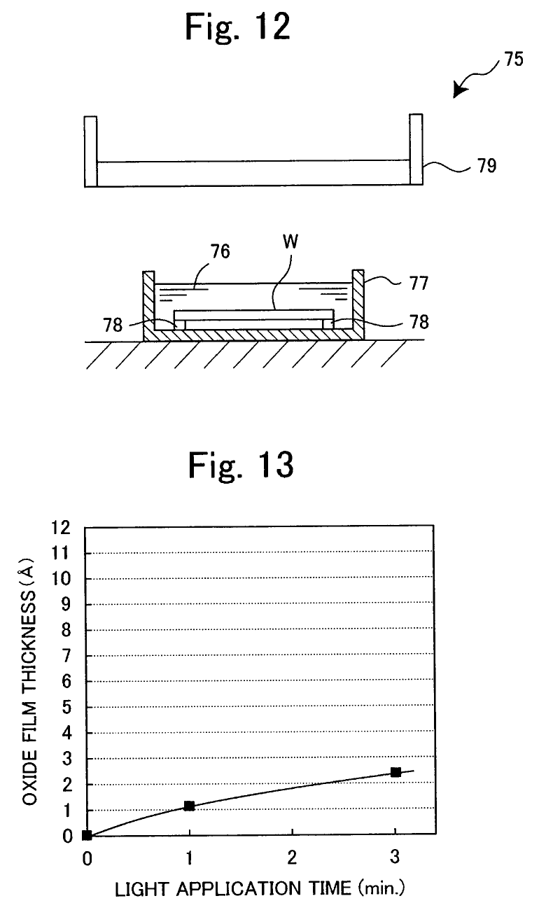

An experiment has been carried out with an experimental apparatus 75 shown in FIG. 12. Firstly, an aqueous solution 76 which contains nitrous oxide to a degree of approximately 0.1% (1.068 ppm) is supplied to a receptacle 77, a silicon substrate W is mounted on protrusions 78, and immersed in the aqueous solution 76. An oxide is removed in advance from a surface of the silicon substrate W with a hydrofluoric acid aqueous solution. Next, ultraviolet light with a wavelength of 240 nm or less, and an output of 110 W, is applied to the silicon substrate W immersed in the aqueous solution 76, by means of a low pressure mercury lamp acting as a light source 79. As a result of this, as shown in FIG. 11, a silicon oxide film of approximately 10 Å is formed by a three minute application of ultraviolet light. The thickness of the silicon oxide film is calculated by an Si2p spectrum wavelength analysis using X-ray Photoelectron Spectroscopy (XPS).

FIG. 13 is a graph showing a relationship between a light application time and a thickness of a silicon oxide film when immersing the silicon substrate W in water in which helium (He) is dissolved in place of nitrous oxide, and applying ultraviolet light, causing a formation of a silicon oxide film. In order to carry out a comparison with the aqueous solution 76 in which nitrous oxide is dissolved, helium is forcibly dissolved in the water to be used in order to expel air elements (N₂, O₂ and CO₂) which are dissolved in the water. As is clear from the graph of FIG. 13, it has been confirmed that an oxide film is formed to an extent of only 1 Å by an ultraviolet light application time of one minute, and to an extent of only 2 Å even by a three minute application time. From a comparison with FIG. 11, it has been confirmed that by applying light to nitrous oxide in water, it is possible to effectively form an oxide film on the surface of the silicon substrate W which is in contact with the aqueous solution 76.

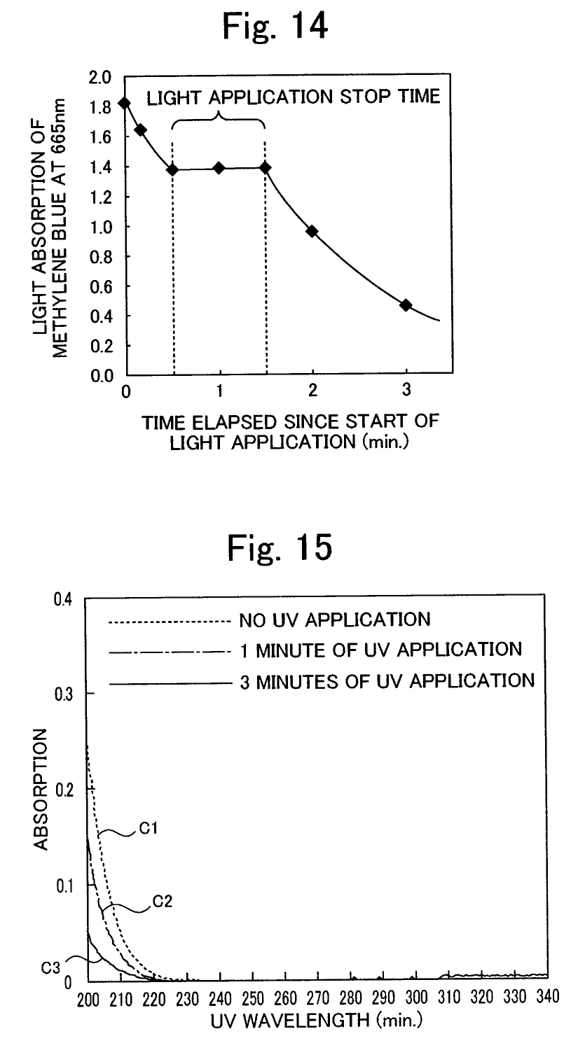

FIG. 14 is a graph showing a relationship between an ultraviolet light application time and a light absorption of a methylene blue aqueous solution 76 at a wavelength of 665 nm, when applying ultraviolet light to the methylene blue aqueous solution 76, in which methylene blue is added to the aqueous solution 76 in which nitrous oxide is dissolved. A horizontal axis shows a time elapsed since starting the application of the ultraviolet light, while a vertical axis shows the light absorption of the methylene blue at the wavelength of 665 nm. The methylene blue takes on a blue color in the aqueous solution 76 condition, but on being oxidized, the blue color disappears, and it becomes colorless. As it carries out an oxidation power evaluation utilizing this property, it is a method which is standard as a photocatalyst oxidation power evaluation. An experiment has been carried out with the experimental apparatus 75 shown in FIG. 12, from which the silicon substrate W has been removed. Firstly, the aqueous solution 76 in which approximately 1,000 ppm of nitrous oxide and 10 ppm of methylene blue are dissolved, has been put into the receptacle 77, ultraviolet light has been applied over a whole of the receptacle by means of a high pressure mercury lamp, with an output of 120 W, acting as the light source 79, and the light absorption of the aqueous solution 76 at the wavelength of 665 nm has been measured.

In FIG. 14, the application of the ultraviolet light to the aqueous solution 76 is stopped at a point at which 0.5 minutes have elapsed since starting the application of the ultraviolet light and, at a point at which a further one minute has elapsed from that point, the ultraviolet light is again applied to the aqueous solution 76. FIG. 14 shows a change of the light absorption of the methylene blue aqueous solution 76 at the wavelength of 665 nm at this time. According to the graph, although the methylene blue breaks down in the aqueous solution 76 along with starting the application of the ultraviolet light, for the one minute from putting the application of the ultraviolet light into a stopped condition, the breaking down of the methylene blue also stops. Subsequently, simultaneously with the ultraviolet light returning to a condition of being applied, the breaking down of the methylene blue begins. From this result, it can be understood that a substance oxidizes depending on an ultraviolet light application time, and that the oxidization of the substance stops in accordance with a blocking of the ultraviolet light, that is, that it is possible to control the oxidization by controlling the time for which the ultraviolet light is applied.

Herein, taking a strength of a light incident on a certain substance to be Ii, and a strength of a light emerging therefrom to be Io, a transmittance (T) of the light is expressed by an equation 1. Then, a light absorption at the time is expressed by an equation 2.

### (Equation 1)

Io/Ii×100=T (transmission) Equation 1

### (Equation 2)

−log T/100=A (light absorption) Equation 2

From the graph of FIG. 14, it has been confirmed that the methylene blue breaks down by an extent of around fifty percent in a continuous application time of one minute, and the methylene blue breaks down by an extent of around ninety percent in a continuous application time of three minutes.

FIG. 15 shows an absorption spectrum of a nitrous oxide aqueous solution (nitrous oxide content approximately 1,000 ppm) when ultraviolet light is applied, using the experimental apparatus 75. There is no methylene blue in the receptacle 77. A horizontal axis shows a wavelength measurement range of 200 to 340 nm, while a vertical axis shows a light absorption. Curved lines C1 to C3 showing a light absorption of nitrous oxide (N₂O), C3 shows a three minute application, C2 a one minute application, and C1 no application. As is clear from the graph, the light absorption being zero with light of a wavelength of 240 nm or more, absolutely no light is absorbed. In other words, it can be understood that no dissociation of nitrous oxide due to an application of light energy takes place.

Table 1 shows a nitrous oxide concentration change obtained from light absorptions at a wavelength of 205 nm shown in FIG. 15. Taking a concentration when the application time is zero as a saturated concentration (a value at a water temperature of 25° C.), a relative value of each light absorption is calculated by multiplication. It can be understood that a nitrous oxide concentration decreases considerably due to a three minute application.

TABLE 1
λ = a change of N₂O concentration
obtained from a light absorption of 205 nm

| Application | Absorption | N₂O | |
|---|---|---|---|
| Time | (relative value) | concentration* | |
| 0 minutes | 0.11855 (100.0%) | 1,068 | ppm |
| 1 minute | 0.06427 (54.2%) | 579 | ppm |
| 3 minutes | 0.02227 (18.8%) | 201 | ppm |

*Taking the concentration at 0 minutes as the saturated concentration (obtained by a calculation at the water temperature of 25° C.), the N₂O concentration is calculated by multiplying the relative value of each light absorption.

Also, according to an experiment result shown in FIG. 15, substantively no by-product of ozone (O₃) has been detected. That is, although a maximum wavelength of ozone (λ max) is 260 nm, a light absorption at that point has been below a limit of detection.

Next, a description will be given of an ultraviolet light which can be utilized in an oxidization, and of a source thereof.

According to results in FIG. 15 and Table 1, an absorption of light by nitrous oxide must be at a wavelength shorter than 240 nm, and it is desirable that a wavelength of light applied to a nitrous oxide aqueous solution is 173 nm or greater, and in a range up to 240 nm. A high pressure mercury lamp, a low pressure mercury lamp, and an ozoneless high pressure mercury lamp are in the range of 173 nm to 240 nm as a wavelength of ultraviolet light.

However, there is a problem in that a breakdown efficiency of nitrous oxide is low due to a reason such as light centered around a wavelength of 200 nm or greater emitted by the high pressure mercury lamp, and light centered around a wavelength of 185 nm emitted by the low pressure mercury lamp, or light centered around a wavelength of 230 nm or greater emitted by the heretofore described ozoneless high pressure mercury lamp, being easily absorbed by oxygen in the atmosphere, or being difficult to absorb by nitrous oxide. Also, there is a problem in that, in the event that the light is easily absorbed by the oxygen in the atmosphere, an amount of ozone generated increases, becoming a burden on the environment.

Therein, it is possible to solve such problems by using a dielectric barrier discharge lamp using krypton-iodine, that is, a KrI excimer lamp, which emits ultraviolet light which has a wavelength of 191 nm as a main component, as a source of the ultraviolet light.

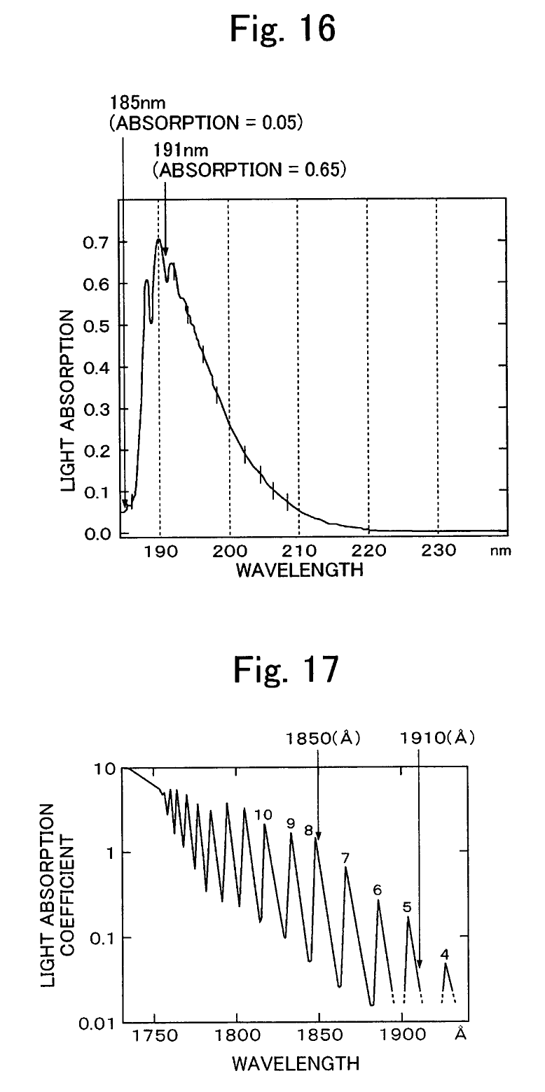

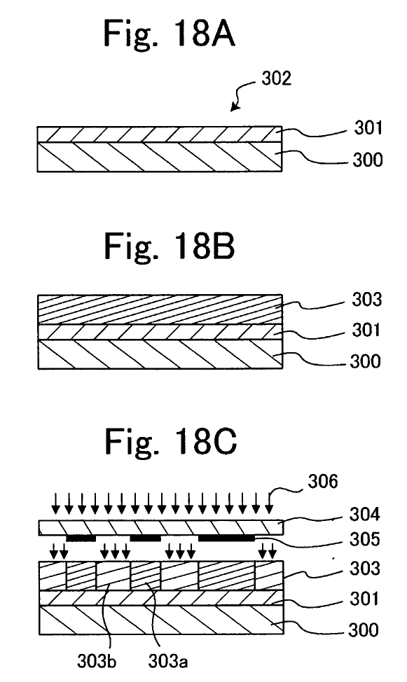

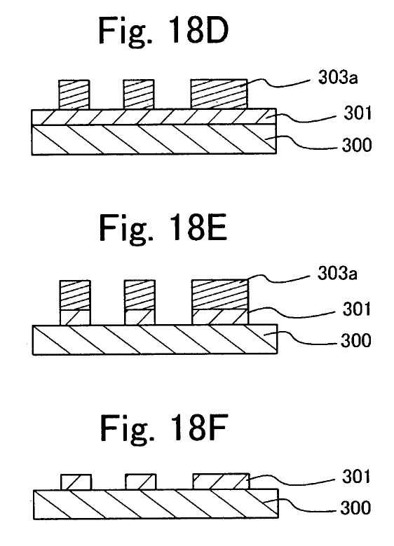

A KrI excimer lamp L has been developed by the inventors based on characteristics of a UV absorption spectrum of a nitrous oxide aqueous solution shown in FIG. 16 (extracted from Brit. J. Anaesth., 44, 310 (1972)), and employed in the wet etching apparatus according to the invention. In FIG. 16, a horizontal axis represents a wavelength, while a vertical axis shows a light absorption. The UV absorption spectrum of the same figure representing an absorption spectrum of water which has reached equilibrium due to 100% nitrous oxide, water equilibrated by helium is used as a reference cell.

As can be understood from FIG. 16, the UV absorption spectrum of the nitrous oxide aqueous solution shows a peak of a light absorption exceeding 0.7 around 190 nm.

A wavelength of light emitted by the low pressure mercury lamp used as the light source 79 shown in FIG. 12 being centered on 185 nm, as a light absorption at a wavelength of 185 nm, at approximately 0.05, is considerably lower than 0.7, which is the peak of the UV absorption spectrum of the nitrous oxide aqueous solution, efficiency is extremely low.

Meanwhile, a dielectric barrier discharge lamp using argon-fluorine, a so-called argon fluoride excimer lamp, is known as a light source which emits light of a wavelength centered around 190 nm at which the UV absorption spectrum of the nitrous oxide aqueous solution shows the peak. The argon fluoride excimer lamp emits light of a wavelength centered on 193 nm.

Generally, the excimer lamp has a characteristic appropriate to the wet etching according to the invention of a start up and shut down being good.

However, with the argon fluoride excimer lamp, a quartz tube ages easily due to fluorine enclosed therein. That is, with the argon fluoride excimer lamp, there is a problem in that, the fluorine and the quartz tube being incompatible, a life span is short. Also, as is clear from FIG. 17, as the UV absorption spectrum of the nitrous oxide aqueous solution is precipitous around the peak, at a wavelength of 193 nm, even though it is near 190 nm, the light absorption decreases considerably in comparison with a peak value.

Therein, the inventors and the like have developed the KrI excimer lamp which emits ultraviolet light of a wavelength which is within a range almost identical to a wavelength of 190 nm, extremely close to the wavelength of 190 nm at which the light absorption by the nitrous oxide aqueous solution is the highest, for example, a wavelength of 191 nm which is within a range of ±1 nm, and employed it in the wet etching apparatus.

The light absorption of the nitrous oxide solution may differ slightly depending on a solvent thereof, and the wavelength at which the light absorption is highest may alter slightly. With the aqueous solution in the example, based on a light absorption peak shape, the range which is almost identical to the wavelength at which the light absorption is the highest is taken as ±1 nm, but as this range differs depending on a kind of solution, or in other words a kind of solvent, it may happen that the range which is almost identical to the wavelength at which the light absorption is the highest also differs depending on the kind.

The KrI excimer lamp is manufactured by a method whereby solid iodine is evaporated, a predetermined amount is measured off, and enclosed in a quartz tube.

As the light absorption of the nitrous oxide aqueous solution at the KrI excimer lamp emitted light wavelength of 191 nm is close, at approximately 0.65, to the light absorption at the peak of the UV absorption spectrum of the nitrous oxide aqueous solution, the efficiency is high. Consequently, when considering the generation of oxygen atoms by a photodissociation of nitrous oxide, as, for example, the light absorption at the low pressure mercury lamp emitted light wavelength of 185 nm is approximately 0.05, it being possible for the KrI excimer lamp to generate oxygen atoms at more than ten times the efficiency compared with the low pressure mercury lamp, a generation efficiency of oxygen atoms is extremely high compared with that of a heretofore known light source.

The KrI excimer lamp, as well as having the characteristic appropriate to the wet etching according to the invention, common to excimer lamps, of the start up and shut down being good, there is an advantage that, as the quartz tube is not easily aged by the enclosed iodine, the iodine and quartz tube are compatible, and a life span is long.

Also, the ultraviolet light with the wavelength of 191 nm emitted by the KrI excimer lamp has energy, sufficiently large to break down the nitrous oxide and carry out an oxidization and reforming reaction, almost identical to that of the ultraviolet light with the wavelength of 185 nm emitted by the low pressure mercury lamp.

Furthermore, it has also been understood that the KrI excimer lamp L has an excellent characteristic in that a generation of ozone by the emitted light is small.

In FIG. 17, a UV absorption spectrum of oxygen is shown (extracted from J. Chem. Phys., 21, 1206 (1953)). In such a spectrum, an extremely fine cyclical fluctuation of an absorption coefficient can be seen in an area from around a wavelength of 175 nm to around a wavelength of 200 nm. Such an area is called a Schumann-Runge band.

The wavelength of 191 nm emitted by the KrI excimer lamp, being included in the Schumann-Runge band, corresponds to, as it were, a valley portion between a 5-0 band and a 4-0 band, and an absorption coefficient is low. In this way, the wavelength of 191 nm emitted by the KrI excimer lamp is a wavelength within a range almost identical to a wavelength at which a light absorption becomes extremely low in the Schumann-Runge band, in which the light absorption due to oxygen molecules changes cyclically. Therefore, the absorption due to the oxygen molecules being low, a dissociation of the oxygen molecules, and a generation of ozone following on therefrom, are low.

Although a range which can be said to be almost identical to the wavelength at which the light absorption becomes extremely low differs, based on a light absorption cyclical fluctuation shape, from a shape between the 5-0 band and the 4-0 band, the wavelength of 191 nm emitted by the KrI excimer lamp can be said to be within the almost identical range.

As the generation of ozone, which becomes a burden on the environment, is low, a handling of the KrI excimer lamp is easy.

Regarding this point, for example, the wavelength of 185 nm of the ultraviolet light emitted by the low pressure mercury lamp being positioned on an 8-0 band in the Schumann-Runge band, the absorption coefficient is large. Therefore, in the event that atmosphere exists between the low pressure mercury lamp and the nitrous oxide aqueous solution, as energy of the ultraviolet light is easily absorbed by the oxygen molecules, and a large amount of ozone is generated, a device for counteracting the ozone being necessary, an oxidization and reforming reaction efficiency is low, leading to a complication of a structure of an apparatus equipped therewith, a design related problem, an enlargement, and an increase in price.

In answer to this, the KrI excimer lamp has the following kinds of advantage.

That is, even in the event that atmosphere exists between the KrI excimer lamp and the nitrous oxide aqueous solution, it being unlikely that the energy of the ultraviolet light emitted from the KrI excimer lamp is absorbed by the oxygen molecules, and therefore unlikely that the ultraviolet light weakens before it reaches the nitrous oxide aqueous solution, it is possible to very efficiently break down the nitrous oxide. Also, as an effect of the atmosphere is small, there is considerable license in a disposition position of the KrI excimer lamp. It is possible to eliminate or simplify a device such as a sealed device such as a process chamber for an ozone countermeasure.

Therefore, the etching of the wet etching apparatus being highly efficient, and a structure being simple, there is considerable license in a design, and it is possible to make the apparatus compact and low-cost.

This is a synergistic effect due to the fact that the wavelength of 191 nm emitted by the KrI excimer lamp simultaneously satisfies two conditions; that it is within a range almost identical to a wavelength at which a light absorption of a solution S is highest, and that it is within a range almost identical to a wavelength at which the light absorption of the oxygen molecules in the Schumann-Runge band is extremely small, and it is produced particularly noticeably. Even in the event that the light source 79 is not the KrI excimer lamp, in a case in which it satisfies only either one of the two such conditions, it has sufficient applicability to the invention.

Next, a description will be given of a solution which breaks down nitrous oxide, a supply of nitrous oxide gas, a method of breaking down nitrous oxide, a concentration detection, and a disposal of waste liquid, which are items related to the wet etching method according to the invention.

Firstly, although it has been previously stated that it is preferable that a solution which breaks down nitrous oxide uses water, as long as it has a transmission capability for light of a wavelength of 240 nm, it is possible to use an organic solution other than water, or a solution in which these are mixed. For example, it is possible to use an organic solution such as methanol, ethanol, isopropanol, methylcyclohexane, cyclohexane, acetonitryl, hexane, dioxane, glycerine, n-pentane, dichloromethane, methyl hydrogen polysiloxane, cyclic dimethylsiloxane, tetramethyl orthosilicate, perfluoro polyether, perfluoro hexane, trimethyl phosphate, triethyl phosphate or tributyl phosphate.

Next, it being possible to supply nitrous oxide gas by means of a gas canister of compressed (liquefied) gas loaded into a high pressure receptacle, it is possible to install this in a vicinity of a processing apparatus such as the etching apparatus. Also, it is also possible to supply it from a large scale high pressure receptacle in a factory or place of manufacture, utilizing a central pipe. Alternatively, it is possible to supply it by mounting a small scale receptacle, such as a cassette type gas canister, on the processing apparatus, or alternatively, to provide a nitrous oxide generating apparatus inside the processing apparatus, in the vicinity of the processing apparatus, or in a workplace, and supply the nitrous oxide generated by the generating apparatus directly to a tank or processing bath inside the processing apparatus.

It is possible to generate nitrous oxide gas in the following way. As an industrial method, it is possible to use, on a practical scale: (1) an ammonia oxidization method which generates nitrous oxide gas by heating ammonia at 200° C. to 500° C., in the presence of a metal oxide catalyst, using oxygen or air, (2) an ammonium nitrate decomposition method which generates nitrous oxide gas by pyrolytically decomposing ammonium nitrate, or by heating an amalgam of nitrate of soda and ammonium nitrate, or (3) a method which supplies sulfamic acid divided into two stages or more, and causes the sulfamic acid and nitric acid to react while adding sulfuric acid.

Also, in a case of producing a small amount, it being possible to generate nitrous oxide by passing ozone gas and nitrogen gas into a glass capillary used in gas chromatography or the like, it is appropriate for efficiently generating a small amount of nitrous oxide gas.

Next, a description will be given of a method of dissolving nitrous oxide gas in a solvent.

As a method of dissolving nitrous oxide gas in a solvent, there is, among others: (1) a method which, installing a diffusion plate or a diffusion tube made of a porous plastic or ceramic material in such a way as to be submerged in a solvent, supplies nitrous oxide gas to the diffusion plate or diffusion tube from the heretofore described gas canister or generating apparatus, causing a bubbling in the solvent, (2) a method which mechanically mixes and dissolves, such as one which, using an ejector, sprays a pressurized solvent from a nozzle of the ejector and, utilizing a negative pressure produced, causes nitrous oxide gas to be sucked into and dissolved in the solvent; one which, using a pressurized shelf plate tower, packed tower, shower tower, bubble tower or the like, brings nitrous oxide gas into contact with a solvent, dissolving it therein; one which churns a solvent in contact with pressurized nitrous oxide gas in a pressure resistant receptacle, dissolving it in the solvent; or one which carries out a high speed churning and mixing of a pressurized solvent and nitrous oxide gas in a small scale, pressure resistant receptacle, dissolving the nitrous oxide gas, (3) a dissolving method using a hollow fiber membrane which dissolves nitrous oxide gas in a solvent, at an optional pressure, without causing air bubbles, by dissolving a gas in a liquid with a porous membrane hollow fiber made of a hydrophobic resin such as polytetrafluoroethylene, utilizing the hydrophobic property of the resin and a gas permeability of the pores, or by, with a non-porous gas permeable membrane hollow fiber, dissolving in a liquid a gas, which has permeated a resin, inside the resin utilizing a gas dissolving and diffusion mechanism.

Furthermore, with these methods, combining ultrasonic waves and a magnetic field which has a gradient, it is possible to increase an amount of nitrous oxide gas dissolved in a solvent, and a dissolution speed.

At a time of applying to the wet etching method of the invention, when taking into consideration a necessary concentration of a nitrous oxide gas and an amount of liquid included in the nitrous oxide, it is preferable to use the hollow fiber membrane as a method of dissolving the nitrous oxide gas in a solvent without waste, efficiently, and in a short time.

Next, a description will be given of a method of controlling and detecting a concentration of nitrous oxide in a solution.

Nitrous oxide in a solution can be maintained at a mostly constant concentration by dissolving nitrous oxide gas in a solvent by means of the predetermined method in the previous description, and controlling a dissolving time, a gas supply pressure, and the like. For this reason, there is an advantage in that it is not absolutely necessary to detect, record and control a nitrous oxide concentration in a solution in a processing apparatus such as the etching apparatus.

However, in a case in which it becomes necessary to closely control a concentration, it is possible to carry out a detection, control and the like of a nitrous oxide concentration in the following ways. It is possible to use, among others: (1) an electrolytic method which, using two or more electrolytic electrodes, a work electrode and counter electrode, and when necessary a reproduction electrode, an ion-exchange membrane which separates the electrodes, and an electrolytic cell which has an electrolytic solution including halogen ions, measures a current flowing when electrolyzing nitrous oxide, or a total number of coulombs at that time, (2) a spectroscopic measurement method which applies ultraviolet rays having a predetermined wavelength to cells accumulated in a solution including nitrous oxide, and measures a light absorption by means of a light receiving system disposed in a position facing a light source across the cell, (3) a TN (Total Nitrogen) analysis method regulated by JIS K0102, or (4) a method which, pressure diffusing, or the like, a non-volatile gas in a solution including nitrous oxide, and moving the nitrous oxide existing in the solution into a gas phase, measures a nitrous oxide concentration in the gas phase by a non-diffusion type infrared absorption method, an ultraviolet absorptiometric method, or an electrochemical type measurement sensor using a solid decomposable matter with an oxygen ion conductive property. It is possible to use these when supplying a solution of the wet etching apparatus of the invention, or in controlling a solution inside a receptacle in which a processing object is immersed.

Next, a description will be given of a nitrous oxide liquid waste disposal.

As only a maximum of around a few hundred ppm of nitrous oxide remain in a solution after processing, by mixing with post-processing rinsing water and waste water from another process, an amount of nitrous oxide in a waste liquid becomes extremely small. For this reason, there is an advantage in that basically there is no need to provide a mechanism inside a processing apparatus for breaking down and removing nitrous oxide.

Also, in a case of implementing a neutralizing process, an activated sludge treatment, an electrolyzing process or the like, in order to dispose of an element other than nitrous oxide in a waste liquid, as it does not happen that the nitrous oxide interferes with these processes, it is possible to implement the sludge process and the like without disposing of the nitrous oxide in the waste liquid. Furthermore, as the nitrous oxide does not cause an abnormal break down like that of an oxidizing agent such as hydrogen peroxide, even in a case of transporting a waste liquid including nitrous oxide to another workplace, a waste product disposal area or the like, there is an advantage in that there is no need to dispose of the nitrous oxide in the waste liquid before transporting it.

However, in a case in which it is necessary, due to a relationship with another process or a relationship with an environmental control of a whole of a workplace, to break down nitrous oxide inside a processing apparatus, or recommend an amount of nitrous oxide discharged from the processing apparatus, as a method of breaking down nitrous oxide in discharged water, there are the following kinds. Being, among others, (1) a method which breaks down the nitrous oxide by applying ultraviolet rays to the waste water for a certain time, (2) a method which carries out an electrolysis with a precious metal such as platinum as an anode, (3) a method which carries out a deoxidizing breakdown by means of a reaction with hydrogen gas in the presence of a catalyst, or (4) a microbial breakdown utilizing micro-organisms which breathe using oxygen in nitrous oxide in an aerobic condition, it is possible to apply these methods, when necessary, to the wet etching apparatus.

In the heretofore described embodiments, the resistive layer 106 is provided between the cathode electrode 104 and the emitter electrode 116 but, not being limited to this, it is also acceptable, for example, not to provide the resistive layer 106 between the cathode electrode 104 and the emitter electrode 116.

Heretofore, a description has been given of the embodiments of the invention but, doing no more than illustrating specific examples, they do not particularly limit the invention. Also, the advantages described in the embodiments of the invention doing no more than enumerate the most preferred advantages arising from the invention, advantages according to the invention are not limited to those described in the embodiments of the invention. Also, regarding the materials (substances) listed in the embodiments of the invention, it may be that there is no problem even in a case of a kind of configuration which omits a predetermined material.

### INDUSTRIAL APPLICABILITY

According to the invention, as a solution in which nitrous oxide (N₂O) is dissolved and a processing object are brought into contact, it is possible to etch the processing object by applying ultraviolet light to the solution in an extreme vicinity of the processing object it is wished to etch away, without using a photo process which uses a photoresist. For this reason, it is possible to reduce a process quantity, and carry out the etching simply. Furthermore, as it is possible to carry out the etching of the processing object without using a hydrogen peroxide solution, it is possible to safely implement a transportation or the like of a waste liquid, with no side reaction of a breakdown of the hydrogen peroxide solution. Also, it becoming easier to recover material of the processing object from the waste liquid, it is possible to provide a wet etching which is effective in an environmental program. Also, according to the invention, as a photolithography process is unnecessary, and furthermore, there is no need to use a hydrogen peroxide solution in an etching solution, a structure being simple and there being considerable license in a design, it is possible to provide a small scale, low cost apparatus.

1-25. (canceled)

26. A wet etching method comprising:
bringing a solution in which nitrous oxide (N₂O) is dissolved into contact with a processing object; and
by applying ultraviolet light to the solution in an area in which it is in contact, dissolving away the processing object in a vicinity of an area to which the ultraviolet light is applied.

27. A wet etching method comprising:
by applying ultraviolet light to a solution in which nitrous oxide (N₂O) is dissolved to dissociate oxygen, allowing the dissociated oxygen to oxidize a processing object to generate an oxide; and
allowing the generated oxide to dissolve in the solution and be removed.

28. The wet etching method according to claim 26, wherein
the solution includes nitrous oxide of a concentration in a range from 10 ppm to 5,000 ppm.

29. The wet etching method according to claim 27, wherein
the solution includes nitrous oxide of a concentration in a range from 10 ppm to 5,000 ppm.

30. The wet etching method according to claim 26, wherein
the solution includes at least any one of water, methanol, ethanol, isopropanol, methylcyclohexane, cyclohexane, acetonitryl, hexane, dioxane, glycerine, n-pentane, or dichloromethane.

31. The wet etching method according to claim 27, wherein
the solution includes at least any one of water, methanol, ethanol, isopropanol, methylcyclohexane, cyclohexane, acetonitryl, hexane, dioxane, glycerine, n-pentane, or dichloromethane.

32. The wet etching method according to claim 26, wherein
the solution is a solution to which an acid or an alkali is added.

33. The wet etching method according to claim 27, wherein
the solution is a solution to which an acid or an alkali is added.

34. The wet etching method according to claim 32, wherein
the solution is a solution which includes any acid of sulfuric acid, phosphoric acid, hydrochloric acid, boric acid, carbonic acid, hydrofluoric acid, nitric acid, formic acid, acetic acid or oxalic acid.

35. The wet etching method according to claim 33, wherein
the solution is a solution which includes any acid of sulfuric acid, phosphoric acid, hydrochloric acid, boric acid, carbonic acid, hydrofluoric acid, nitric acid, formic acid, acetic acid or oxalic acid.

36. The wet etching method according to claim 32, wherein
the solution is a solution which includes any alkali of ammonia, sodium hydroxide, potassium hydroxide, or tetramethylammonium hydroxide.

37. The wet etching method according to claim 33, wherein
the solution is a solution which includes any alkali of ammonia, sodium hydroxide, potassium hydroxide, or tetramethylammonium hydroxide.

38. The wet etching method according to claim 26, wherein
the ultraviolet light is ultraviolet light having a spectrum with a wavelength range of 173 nm to 240 nm.

39. The wet etching method according to claim 27, wherein
the ultraviolet light is ultraviolet light having a spectrum with a wavelength range of 173 nm to 240 nm.

40. The wet etching method according to claim 26, wherein
the ultraviolet light is ultraviolet light emitted by a mercury lamp.

41. The wet etching method according to claim 27, wherein
the ultraviolet light is ultraviolet light emitted by a mercury lamp.

42. The wet etching method according to claim 26, wherein
the ultraviolet light is ultraviolet light emitted by an excimer lamp.

43. The wet etching method according to claim 27, wherein
the ultraviolet light is ultraviolet light emitted by an excimer lamp.

44. The wet etching method according to claim 26, wherein
the processing object is one kind chosen from silicon, aluminium, copper, iron, zinc, titanium, tantalum, silver, zirconium, tungsten, chromium, molybdenum, nickel, hafnium, ruthenium, niobium, yttrium, scandium, neodymium, lanthanum, cerium, cobalt, vanadium, manganese, gallium, germanium, indium, tin, rhodium, palladium, cadmium, antimony, or an alloy including these.

45. The wet etching method according to claim 27, wherein
the processing object is one kind chosen from silicon, aluminium, copper, iron, zinc, titanium, tantalum, silver, zirconium, tungsten, chromium, molybdenum, nickel, hafnium, ruthenium, niobium, yttrium, scandium, neodymium, lanthanum, cerium, cobalt, vanadium, manganese, gallium, germanium, indium, tin, rhodium, palladium, cadmium, antimony, or an alloy including these.

46. The wet etching method according to claim 26, wherein
the processing object is a processing substrate wherein a copper film is formed on the substrate.

47. The wet etching method according to claim 27, wherein
the processing object is a processing substrate wherein a copper film is formed on the substrate.

48. The wet etching method according to claim 26, wherein
the processing object is a silicon substrate.

49. The wet etching method according to claim 27, wherein
the processing object is a silicon substrate.

50. The wet etching method according to claim 26, wherein
the processing object is a processing substrate wherein a molybdenum film is formed on the substrate.

51. The wet etching method according to claim 27, wherein
the processing object is a processing substrate wherein a molybdenum film is formed on the substrate.

52. The wet etching method according to claim 26, wherein
the ultraviolet light is locally applied to the solution in a vicinity of the processing object.

53. The wet etching method according to claim 27, wherein
the ultraviolet light is locally applied to the solution in a vicinity of the processing object.

54. The wet etching method according to claim 26, wherein
the ultraviolet light is applied to the solution in the vicinity of the processing object except for in portions blocked by a mask.

55. The wet etching method according to claim 27, wherein
the ultraviolet light is applied to the solution in the vicinity of the processing object except for in portions blocked by a mask.

56. The wet etching method according to claim 26, wherein
a volume of the processing object dissolved away is controlled by controlling an application time of the ultraviolet light.

57. The wet etching method according to claim 27, wherein
a volume of the processing object dissolved away is controlled by controlling an application time of the ultraviolet light.

58. The wet etching method according to claim 26, wherein
a depth to which the processing object is dissolved away is controlled by controlling the application time of the ultraviolet light.

59. The wet etching method according to claim 27, wherein a depth to which the processing object is dissolved away is controlled by controlling the application time of the ultraviolet light.

60. The wet etching method according to claim 26, wherein
the processing object is brought into contact with the solution by immersing it therein.

61. The wet etching method according to claim 27, wherein
the processing object is brought into contact with the solution by immersing it therein.

62. The wet etching method according to claim 26, wherein
the solution is supplied to, and brought into contact with, a surface of the processing object.

63. The wet etching method according to claim 27, wherein
the solution is supplied to, and brought into contact with, a surface of the processing object.

64. A wet etching apparatus comprising:
contact means which brings a solution in which nitrous oxide is dissolved into contact with a processing object; and
light application means which applies ultraviolet light to the solution in an area in which it is in contact, wherein
the apparatus is configured in such a way as to etch the processing object in a vicinity of an area to which the ultraviolet light is applied by the light application means.

65. The wet etching apparatus according to claim 64, wherein the contact means includes:
solution holding means for holding the solution in which the nitrous oxide is dissolved; and
processing object holding means for holding the processing object, and the light application means includes:
a light source which emits ultraviolet light; and
mask supporting means for interposing a light intercepting mask between the light source and the processing object holding means.

66. The wet etching apparatus according to claim 64, wherein the contact means includes:
the solution holding means for holding the solution in which the nitrous oxide is dissolved;
the processing object holding means for holding the processing object; and
solution supply means for supplying the solution from the solution holding means to the processing object,
and the light application means includes:
the mask supporting means for interposing the light intercepting mask between the light source and the processing object holding means.

67. The wet etching apparatus according to claim 64, wherein the light application means includes:
the light source which emits the ultraviolet light; and
optical path adjustment means for applying the emitted ultraviolet light to the processing object.

68. The wet etching apparatus according to claim 64, wherein
the optical path adjustment means includes a lens made of quartz for collecting the ultraviolet light.
